(19) United States
(12) Patent Application Publication
(10) Pub. No.: US 2010/0099774 A1
(43) Pub. Date: Apr. 22, 2010

(54) Method for Controlling Harmful Fungi

(75) Inventors: Henry Van Tuyl Cotter, Raleigh, NC (US); David Allen Hunt, Yardley, PA (US); David G. Kuhn, Apex, NC (US)

Correspondence Address: BRINKS, HOFER, GILSON & LIONE, P.O. BOX 1340, MORRISVILLE, NC, 27560, US

(73) Assignee: BASF SE, Ludwigshafen (DE)

(21) Appl. No.: 12/523,804

(22) PCT Filed: Jan. 28, 2008
(86) PCT No.: PCT/EP2008/050926

§ 371 Date: Jul. 20, 2009

Related U.S. Application Data
(60) Provisional application No. 60/887,646, filed on Feb. 1, 2007.

(51) Int. Cl. A01N 33/02; A01P 3/00

(52) U.S. Cl. 514/646

(57) ABSTRACT

The present invention relates to a method for controlling phytopathogenic fungior harmful fungi in the protection of materials, wherein the fungi or the materials, plants, soil or seed to be protected against fungal attack are treated with a fungicidally effective amount of an amidrazone of the formula (I) wherein R, R¹, R², R³, A, B, W, Y and n have the meanings as defined in the description.

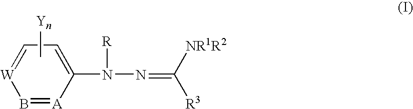

The present invention relates to a method for controlling phytopathogenic fungi or harmful fungi in the protection of materials, wherein the fungi or the materials, plants, soil or seed to be protected against fungal attack are treated with a fungicidally effective amount of an amidrazone of the formula I

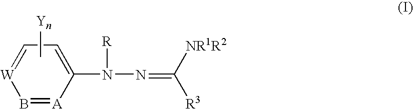

wherein
R is hydrogen, C₁-C₆-alkyl, C₁-C₆-alkoxycarbonyl, C₁-C₆-alkylaminocarbonyl, or di(C₁-C₆-alkyl)-aminocarbonyl,
   wherein in each of the above radicals the alkyl group is unsubstituted or substituted with 1 to 3 substituents independently selected from halogen, cyano, nitro, C₁-C₆-alkoxy, C₂-C₆-alkenyloxy, C₂-C₆-alkynyloxy, C₁-C₆-haloalkoxy, C₁-C₆-alkylthio, C₁-C₆-haloalkylthio, C₁-C₆-alkylsulfonyl, and C₁-C₆-alkylsulfinyl, di(C₁-C₆alkyl)-amino;
R¹ and R² are each independently hydrogen, C₁-C₁₀-alkyl, C₃-C₁₀-alkenyl, C₃-C₁₀-alkynyl, C₃-C₁₂-cycloalkyl, C₁-C₆-alkylamino, di(C₁-C₆-alkyl)-amino, C₁-C₆-alkylcarbonylamino, or C₁-C₆-alkylsulfonyl, C₁-C₆-alkylsulfinyl;
   wherein in each of the above radicals the alkyl, alkenyl, alkynyl or cycloalkyl groups are unsubstituted or substituted with 1 to 3 substituents independently selected from halogen, nitro, cyano, C₁-C₆-alkoxy, C₁-C₆-haloalkoxy, C₁-C₆-alkylthio, C₁-C₆-haloalkylthio, C₁-C₆-alkylsulfonyl, C₁-C₆-alkylsulfinyl, C₁-C₆-haloalkylsulfonyl, C₁-C₆-haloalkylsulfinyl, C₃-C₆-cycloalkyl, phenyl, and pyridyl;
R³ is C₁-C₁₀-alkyl, C₂-C₁₀-alkenyl, C₂-C₁₀-alkynyl, C₃-C₁₂-cycloalkyl,
   wherein in each of the above radicals the alkyl, alkenyl, alkynyl or cycloalkyl groups are unsubstituted or partially or fully halogenated and/or substituted with
      1 to 3 substituents independently selected from cyano, nitro, hydroxy, mercapto, amino, C₁-C₆-alkyl, C₃-C₆-cycloalkyl, C₁-C₆-alkoxy, C₁-C₆-alkylamino, di(C₁-C₆-alkyl)-amino, C₁-C₆-alkylthio, C₁-C₆-alkylsulfonyl, and C₁-C₆-alkylsulfinyl,
   or a 3- to 6-membered saturated or partially unsaturated ring which may contain 1 to 3 heteroatoms selected from oxygen, sulfur and nitrogen, and which is unsubstituted or substituted with 1 to 5 substituents independently selected from halogen, C₁-C₆-alkyl, C₁-C₆-alkylthio, C₁-C₆-alkylsulfonyl, C₁-C₆-alkylsulfinyl, C₁-C₆-alkoxy, C₁-C₆-haloalkoxy, nitro and cyano, wherein in each of the above radicals the alkyl group is unsubstituted or substituted with 1 to 3 halogen atoms;
A is C—R⁴ or N;
B is C—R⁵or N;
W is C—R⁶ or N;
   with the proviso that one of A, B and W is other than N;
      R⁴, R⁵, R⁶ are each independently hydrogen, halogen, nitro, cyano, amino, mercapto, hydroxy, C₁-C₁₀-alkyl, C₂-C₁₀-alkenyl, C₂-C₁₀-alkynyl, C₃-C₆-cycloalkyl, C₁-C₆-alkoxy, C₁-C₆-alkylamino, di(C₁-C₆-alkyl)-amino, C₁-C₆-alkylthio, C₁-C₆-alkylsulfonyl, C₁-C₆-alkylsulfinyl, or a 5- to 6-membered aromatic ring which may contain 1 to 4 heteroatoms selected from oxygen, sulfur and nitrogen;
Y is hydrogen, halogen, cyano, nitro, amino, hydroxy, mercapto, C₁-C₆-alkyl, C₂-C₁₀-alkenyl, C₂-C₁₀-alkynyl, C₃-C₆-cycloalkyl, C₁-C₆-alkoxy, C₁-C₆-alkylamino, di(C₁-C₆)-alkylamino, C₁-C₆-alkylthio, C₁-C₆-alkylsulfonyl, or C₁-C₆-alkylsulfinyl; and
n is 0, 1, or 2.

This invention furthermore relates to the use of the amidrazone of the formula I for controlling phytopathogenic harmful fungi or harmful fungi the protection of materials.

It has been already known that amidrazones show insecticidal activity (cf. for example, EP-A 604 798, J. A. Furch et al., “Amidrazones: A New Class of Coleopteran Insecticides”, ACS Symposium Series 686, Am. Chem. Soc., 1998, Chapter 18, pp. 178; and D. G. Kuhn et al., “Cycloalkyl-substituted Amidrazones: A Novel Class of Insect Control Agents”, ACS Symposium Series 686, Am. Chem. Soc., 1998, Chapter 19, pp. 185).

Surprisingly, it has now been found that the amidrazones of the formula (I) possess fungicidal activity.

The amidrazones of formula I can be obtained by the preparation methods as described or referenced in EP-A 604 798. Moreover, an alternative route for their preparation is disclosed in co-pending European patent application No. 06118365.3 filed on Aug. 3, 2006.

In the definitions of the variables specified in the formulae I, I-A and I-B, collective terms were used which are generally representative of particular substituents. The term Cₐ-C_{b} specifies the number of carbon atoms in the particular substituents or substituent moiety which is possible in each case. Other definitions are as follows:

“Halogen” will be taken to mean fluorine, chlorine, bromine, and iodine.

The term “halo” refers to fluoro, chloro, bromo, and iodo.

The term “alkyl” as used herein refers to a branched or unbranched saturated hydrocarbon group having 1 to 10 carbon atoms, especially C₁-C₆-alkyl such as methyl, ethyl, propyl, 1-methylethyl, butyl, 1-methylpropyl, 2-methylpropyl, 1,1-dimethylethyl, pentyl, 1-methylbutyl, 2-methylbutyl, 3-methylbutyl, 2,2-di methyl propyl, 1-ethylpropyl, hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl and 1-ethyl-2-methylpropyl.

The term “haloalkyl” as used herein refers to a straight-chain or branched alkyl groups having 1 to 10 carbon atoms (as mentioned above), where some or all of the hydrogen atoms in these groups may be replaced by halogen atoms as mentioned above, for example C₁-C₂-haloalkyl, such as chloromethyl, bromomethyl, dichloromethyl, trichloromethyl, fluoromethyl, difluoromethyl, trifluoromethyl, chlorofluoromethyl, dichlorofluoromethyl, chlorodifluoromethyl, 1-chloroethyl, 1-bromoethyl, 1-fluoroethyl, 2-fluoroethyl, 2,2-difluoroethyl, 2,2,2-trifluoroethyl, 2-chloro-2-fluoroethyl, 2-chloro-2,2-difluoroethyl, 2,2-dichloro-2-fluoroethyl, 2,2,2-trichloroethyl and pentafluoroethyl.

Similarly, “alkoxy” and “alkylthio” refer to straight-chain or branched alkyl groups having 1 to 6 carbon atoms (as mentioned above) bonded through oxygen or sulfur linkages, respectively, at any bond in the alkyl group. Examples include methoxy, ethoxy, propoxy, isopropoxy, methylthio, ethylthio, propylthio, isopropylthio, and n-butylthio.

Similarly, “alkylsulfinyl” and “alkylsulfonyl” refer to straight-chain or branched alkyl groups having 1 to 6 carbon atoms (as mentioned above) bonded through —S(═O)— or —S(═O)₂— linkages, respectively, at any bond in the alkyl group. Examples include methylsulfinyl and methylsulfonyl.

Similarly, “alkylamino” refers to a nitrogen atom which carries 1 or 2 straight-chain or branched alkyl groups having 1 to 6 carbon atoms (as mentioned above) which may be the same or different. Examples include methylamino, dimethylamino, ethylamino, diethylamino, methylethylamino, isopropylamino, or methylisopropylamino.

The term “alkylcarbonyl” refers to straight-chain or branched alkyl groups having 1 to 6 carbon atoms (as mentioned above) bonded through a —C(═O)— linkage, respectively, at any bond in the alkyl group. Examples include acetyl and propionyl.

The term “alkenyl” as used herein intends a branched or unbranched unsaturated hydrocarbon group having 3 to 10 carbon atoms and a double bond in any position, such as C₃-C₆ alkenyl such as 1-propenyl, 2-propenyl, 1-methyl-ethenyl, 1-butenyl, 2-butenyl, 3-butenyl, 1-methyl-1-propenyl, 2-methyl-1-propenyl, 1-methyl-2-propenyl, 2-methyl-2-propenyl; 1-pentenyl, 2-pentenyl, 3-pentenyl, 4-pentenyl, 1-methyl-1-butenyl, 2-methyl-1-butenyl, 3-methyl-1-butenyl, 1-methyl-2-butenyl, 2-methyl-2-butenyl, 3-methyl-2-butenyl, 1-methyl-3-butenyl, 2-methyl-3-butenyl, 3-methyl-3-butenyl, 1,1-dimethyl-2-propenyl, 1,2-dimethyl-1-propenyl, 1,2-dimethyl-2-propenyl, 1-ethyl-1-propenyl, 1-ethyl-2-propenyl, 1-hexenyl, 2-hexenyl, 3-hexenyl, 4-hexenyl, 5-hexenyl, 1-methyl-1-pentenyl, 2-methyl-1-pentenyl, 3-methyl-1-pentenyl, 4-methyl-1-pentenyl, 1-methyl-2-pentenyl, 2-methyl-2-pentenyl, 3-methyl-2-pentenyl, 4-methyl-2-pentenyl, 1-methyl-3-pentenyl, 2-methyl-3-pentenyl, 3-methyl-3-pentenyl, 4-methyl-3-pentenyl, 1-methyl-4-pentenyl, 2-methyl-4-pentenyl, 3-methyl-4-pentenyl, 4-methyl-4-pentenyl, 1,1-dimethyl-2-butenyl, 1,1-dimethyl-3-butenyl, 1,2-dimethyl-1-butenyl, 1,2-dimethyl-2-butenyl, 1,2-dimethyl-3-butenyl, 1,3-dimethyl-1-butenyl, 1,3-dimethyl-2-butenyl, 1,3-dimethyl-3-butenyl, 2,2-dimethyl-3-butenyl, 2,3-dimethyl-1-butenyl, 2,3-dimethyl-2-butenyl, 2,3-dimethyl-3-butenyl, 3,3-dimethyl-1-butenyl, 3,3-dimethyl-2-butenyl, 1-ethyl-1-butenyl, 1-ethyl-2-butenyl, 1-ethyl-3-butenyl, 2-ethyl-1-butenyl, 2-ethyl-2-butenyl, 2-ethyl-3-butenyl, 1,1,2-trimethyl-2-propenyl, 1-ethyl-1-methyl-2-propenyl, 1-ethyl-2-methyl-1-propenyl and 1-ethyl-2-methyl-2-propenyl.

The term “alkynyl” as used herein refers to a branched or unbranched unsaturated hydrocarbon group containing at least one triple bond, such as ethynyl, propynyl, 1-butynyl, 2-butynyl and the like.

“Cycloalkyl” refers to a monocyclic 3- to 8-, 10- or 12-membered saturated carbon atom rings, e.g. C₃-C₈-cycloalkyl such as cyclopropyl, cyclobutyl, cyclopentyl, cyclohexyl, cycloheptyl and cyclooctyl.

The term “aryl” refers to an aromatic carbocyclic group having at least one aromatic ring (e.g., phenyl or biphenyl) or multiple condensed rings in which at least one ring is aromatic, (e.g., 1,2,3,4-tetrahydronaphthyl, naphthyl, anthryl, or phenanthryl), each of which may be substituted.

A 5- to 6-membered aromatic ring containing 1 to 4 heteroatoms selected from oxygen, sulfur and nitrogen, intends e.g. 5-membered heteroaryl, containing 1 to 4 nitrogen atoms or 1 to 3 nitrogen atoms and 1 sulfur or oxygen atom, e.g. furyl, thienyl, pyrrolyl, isoxazolyl, isothiazolyl, pyrazolyl, oxazolyl, thiazolyl, imidazolyl, oxadiazolyl, thiadiazolyl, oxadiazolyl, triazolyl, and tetrazolyl; or 6-membered heteroaryl, containing 1 to 4 nitrogen atoms or 1 to 3 nitrogen atoms and 1 sulfur or oxygen atom, e.g. 2-pyridinyl, 3-pyridinyl, 4-pyridinyl, 3-pyridazinyl, 4-pyridazinyl, 2-pyrimidinyl, 4-pyrimidinyl, 5-pyrimidinyl, 2-pyrazinyl, 1,3,5-triazin-2-yl and 1,2,4-triazin-3-yl.

A 3- to 6-membered saturated or partially unsaturated ring which contains 1 to 3 heteroatoms selected from oxygen, sulfur and nitrogen intends e.g. a saturated 3- to 6-membered ring containing 1 to 3 heteroatoms selected from nitrogen and oxygen, such as aziridine, pyrrolidine, tetrahydrofuran, tetrahydropyran, or piperidine.

With a view to the intended use of the compounds of the formula I, preference is given to the following meanings of the substituents and indices, in each case on their own or in combination:

In one embodiment of the compounds of formula I, A denotes C—R⁴.

In a further embodiment of the compounds of formula I, B denotes C—R⁵.

In a further embodiment of the compounds I, W denotes C—R⁶.

In a further embodiment of the compounds I, A denotes C—R⁴, B denotes C—R⁵, and W denotes C—R⁶.

In a further embodiment of the compounds I, R⁴ is halogen or C₁-C₆-haloalkyl, preferably halogen, especially chlorine or bromine, with chlorine being most preferred.

In a further embodiment of the compounds I, R⁵ is hydrogen or halogen, especially hydrogen.

In a further embodiment of the compounds I, R⁶ is halogen or C₁-C₆-haloalkyl, preferably C₁-C₆-haloalkyl, especially trifluoromethyl.

In a further embodiment of the compounds I, Y is halogen or C₁-C₆-haloalkyl, in particular halogen or C₁-C₆-haloalkyl which is disposed in the 6-position.

In a further embodiment of the compounds I, Y is halogen, especially chlorine.

In a further embodiment of the compounds I, Y is halogen, in particular chlorine, which is disposed in the 6-position.

In a further embodiment of the compounds I, n is 1.

In a further embodiment of the compounds I, R denotes hydrogen or C₁-C₆-alkyl, in particular hydrogen.

In a further embodiment of the compounds I, R¹ and R² each independently are hydrogen, C₁-C₁₀-alkyl which is unsubstituted or substituted by C₁-C₄-alkoxy, or C₃-C₁₀-cycloalkyl which is unsubstituted or substituted with from 1 to 3 halogen.

In a further embodiment of the compounds I, R¹ and R² each independently are hydrogen, C₁-C₄-alkyl, or C₃-C₆-cycloalkyl.

In a further embodiment of the compounds I, R¹ is hydrogen and R² is C₁-C₁₀-alkyl which is unsubstituted or substituted by C₁-C₄-alkoxy, or C₃-C₁₀-cycloalkyl which is unsubstituted or substituted with from 1 to 3 halogen.

In a further embodiment of the compounds I, R¹ is hydrogen and R² is C₁-C₄-alkyl or C₃-C₆-cycloalkyl.

In a further embodiment of the compounds I, R¹ is hydrogen and R² is C₁-C₄-alkyl, in particular ethyl.

In a further embodiment of the compounds I, R³ is unsubstituted C₁-C₁₀-alkyl or C₃-C₁₀-cycloalkyl, which is unsubstituted or substituted with 1 to 5 halogen atoms and/or 1 to 3 C₁-C₆-alkyl groups.

In a further embodiment of the compounds I, R³ is C₁-C₁₀-alkyl, in particular C₁-C₆-alkyl, with tert-butyl being the most preferred.

In a further embodiment of the compounds I, R³ is cyclopropyl which is unsubstituted or substituted with C₁-C₆-alkyl or halogen.

In a further embodiment of the compounds I, R³ is C₃-C₁₀-cycloalkyl which is unsubstituted or substituted with 1 to 5 halogen atoms and/or 1 to 3 C₁-C₆-alkyl groups and/or 1 to 3 C₁-C₆-haloalkyl groups.

In a further embodiment of the compounds I, R³ is cyclopropyl which is unsubstituted or substituted with 1 to 3 halogen atoms and/or 1 to 3 C₁-C₆-alkyl groups and/or 1 to 3 C₁-C₆-haloalkyl groups.

In a further embodiment of the compounds I, R³ is cyclopropyl which is substituted with 2 halogen atoms and/or 1 C₁-C₆-alkyl group, in particular cyclopropyl which is substituted with 2 chlorine atoms and/or 1 methyl group.

In a further embodiment of the compounds I, R³ is a cyclopropyl group of formula II

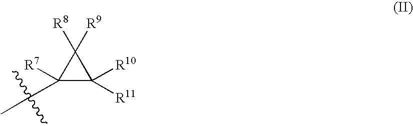

wherein R⁷ is hydrogen, C₁-C₆-alkyl or C₁-C₆-haloalkyl, and R⁸, R⁹, R¹⁰ and R¹¹ are each independently selected from hydrogen, halogen, C₁-C₆-alkyl and C₁-C₆-haloalkyl.

In a further embodiment of the compounds I, R³ is a cyclopropyl group of formula II wherein R⁷ is hydrogen, C₁-C₆-alkyl or C₁-C₆-haloalkyl, R⁸ and R⁹ are both halogen, and R¹⁰ and R¹¹ are both hydrogen.

In a further embodiment of the compounds I, R³ is a cyclopropyl group of formula II wherein R⁷ is C₁-C₆-alkyl, R⁸ and R⁹ are both halogen, and R¹⁰ and R¹¹ are both hydrogen.

In a further embodiment of the compounds I, R³ is a cyclopropyl group of formula II wherein R⁷ is hydrogen, methyl or trifluoromethyl, R⁸ and R⁹ are independently selected from fluoro, chloro and bromo, and R¹⁰ and R¹¹ are both hydrogen.

In a further embodiment of the compounds I, R³ is a cyclopropyl group of formula II wherein R⁷ is hydrogen or methyl, R⁸ and R⁹ are chloro or bromo, and R¹⁰ and R¹¹ are both hydrogen.

In a further embodiment of the compounds I, R³ is a cyclopropyl group of formula II wherein R⁷ is methyl, R⁸ and R⁹ are chloro or bromo, and R¹⁰ and R¹¹ are both hydrogen, in particular a cyclopropyl group of formula II wherein R⁷ is methyl, R⁸ and R⁹ are both chloro, and R¹⁰ and R¹¹ are both hydrogen, i.e. 1-(2,2-dichloro-1-methylcyclopropyl).

With respect to their use, preference is given to the compounds I-A compiled in the tables below. Moreover, the groups mentioned for a substituent in the tables are on their own, independently of the combination in which they are mentioned, a particularly preferred embodiment of the substituent in question.

Table 1

Compounds of the formula I-A wherein R³ is methyl and the combination of R¹, R², R⁴, R⁵, R⁶ and Yₙ corresponds in each case to a row of Table A.

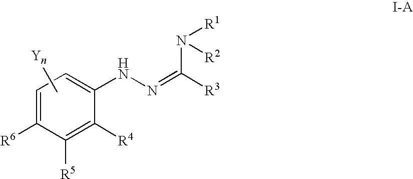

Table 2

Compounds of the formula I-A wherein R³ is ethyl and the combination of R¹, R², R⁴, R⁵, R⁶ and Yₙ corresponds in each case to a row of Table A.

Table 3

Compounds of the formula I-A wherein R³ is propyl and the combination of R¹, R², R⁴, R⁵, R⁶ and Yₙ corresponds in each case to a row of Table A.

Table 4

Compounds of the formula I-A wherein R³ is isopropyl and the combination of R¹, R², R⁴, R⁵, R⁶ and Yₙ corresponds in each case to a row of Table A.

Table 5

Compounds of the formula I-A wherein R³ is isobutyl and the combination of R¹, R², R⁴, R⁵, R⁶ and Yₙ corresponds in each case to a row of Table A.

Table 6

Compounds of the formula I-A wherein R³ is tert-butyl and the combination of R¹, R², R⁴, R⁵, R⁶ and Yₙ corresponds in each case to a row of Table A.

Table 7

Compounds of the formula I-A wherein R³ is neopentyl and the combination of R¹, R², R⁴, R⁵, R⁶ and Yₙ corresponds in each case to a row of Table A.

Table 8

Compounds of the formula I-A wherein R³ is 1,1-dimethyl-propyl and the combination of R¹, R², R⁴, R⁵, R⁶ and Yₙ corresponds in each case to a row of Table A.

Table 9

Compounds of the formula I-A wherein R³ is cyclopropyl and the combination of R¹, R², R⁴, R⁵, R⁶ and Yₙ corresponds in each case to a row of Table A.

Table 10

Compounds of the formula I-A wherein R³ is 1-(2,2-dichloro-cyclopropyl) and the combination of R¹, R², R⁴, R⁵, R⁶ and Yₙ corresponds in each case to a row of Table A.

Table 11

Compounds of the formula I-A wherein R³ is 1-(2,2-dibromo-cyclopropyl) and the combination of R¹, R², R⁴, R⁵, R⁶ and Yₙ corresponds in each case to a row of Table A.

Table 12

Compounds of the formula I-A wherein R³ is 1-(1-methyl-cyclopropyl) and the combination of R¹, R², R⁴, R⁵, R⁶ and Yₙ corresponds in each case to a row of Table A.

Table 13

Compounds of the formula I-A wherein R³ is 1-(2,2-dichloro-1-methyl-cyclopropyl) and the combination of R¹, R², R⁴, R⁵, R⁶ and Yₙ corresponds in each case to a row of Table A.

Table 14

Compounds of the formula I-A wherein R³ is 1-(2,2-dibromo-1-methyl-cyclopropyl) and the combination of R¹, R², R⁴, R⁵, R⁶ and Yₙ corresponds in each case to a row of Table A.

TABLE A

| No. | R¹ | R² | R⁴ | R⁵ | R⁶ | Yₙ |
|---|---|---|---|---|---|---|
| A-1 | H | H | Cl | H | H | H |
| A-2 | CH₃ | CH₃ | Cl | H | H | H |
| A-3 | CH₂CH₃ | CH₂CH₃ | Cl | H | H | H |
| A-4 | CH₃ | H | Cl | H | H | H |
| A-5 | CH₂CH₃ | H | Cl | H | H | H |
| A-6 | (CH₂)₂CH₃ | H | Cl | H | H | H |
| A-7 | CH(CH₃)₂ | H | Cl | H | H | H |
| A-8 | CH₂CF₃ | H | Cl | H | H | H |
| A-9 | C(CH₃)₃ | H | Cl | H | H | H |
| A-10 | CH₂CH(CH₃)₂ | H | Cl | H | H | H |
| A-11 | CH(CH₃)CH₂CH₃ | H | Cl | H | H | H |
| A-12 | (CH₂)₂OCH₃ | H | Cl | H | H | H |
| A-13 | CH₂CH(OCH₃)₂ | H | Cl | H | H | H |
| A-14 | CH₂CH(OCH₂CH₃)₂ | H | Cl | H | H | H |
| A-15 | CH₂C₆H₅ | H | Cl | H | H | H |
| A-16 | CH(CH₃)C₆H₅ | H | Cl | H | H | H |
| A-17 | (CH₂)₂OC₆H₅ | H | Cl | H | H | H |
| A-18 | (CH₂)₂C₆H₅ | H | Cl | H | H | H |
| A-19 | (CH₂)₂C₆H₄F | H | Cl | H | H | H |
| A-20 | (CH₂)₂C₆H₄Cl | H | Cl | H | H | H |
| A-21 | (CH₂)₂C₆H₄CN | H | Cl | H | H | H |
| A-22 | (CH₂)₂C₆H₄CH₃ | H | Cl | H | H | H |
| A-23 | (CH₂)₂C₆H₄CF₃ | H | Cl | H | H | H |
| A-24 | (CH₂)₂C₆H₄OCH₃ | H | Cl | H | H | H |
| A-25 | (CH₂)₂C₆H₄OCF₃ | H | Cl | H | H | H |
| A-26 | CH₂CH═CH₂ | H | Cl | H | H | H |
| A-27 | cyclo-C₃H₅ | H | Cl | H | H | H |
| A-28 | (CH₂)₂NHCH₃ | H | Cl | H | H | H |
| A-29 | H | H | F | H | H | H |
| A-30 | CH₃ | CH₃ | F | H | H | H |
| A-31 | CH₂CH₃ | CH₂CH₃ | F | H | H | H |
| A-32 | CH₃ | H | F | H | H | H |
| A-33 | CH₂CH₃ | H | F | H | H | H |
| A-34 | (CH₂)₂CH₃ | H | F | H | H | H |
| A-35 | CH(CH₃)₂ | H | F | H | H | H |
| A-36 | CH₂CF₃ | H | F | H | H | H |
| A-37 | C(CH₃)₃ | H | F | H | H | H |
| A-38 | CH₂CH(CH₃)₂ | H | F | H | H | H |
| A-39 | CH(CH₃)CH₂CH₃ | H | F | H | H | H |
| A-40 | (CH₂)₂OCH₃ | H | F | H | H | H |
| A-41 | CH₂CH(OCH₃)₂ | H | F | H | H | H |
| A-42 | CH₂CH(OCH₂CH₃)₂ | H | F | H | H | H |
| A-43 | CH₂C₆H₅ | H | F | H | H | H |
| A-44 | CH(CH₃)C₆H₅ | H | F | H | H | H |
| A-45 | (CH₂)₂OC₆H₅ | H | F | H | H | H |
| A-46 | (CH₂)₂C₆H₅ | H | F | H | H | H |
| A-47 | (CH₂)₂C₆H₄F | H | F | H | H | H |
| A-48 | (CH₂)₂C₆H₄Cl | H | F | H | H | H |
| A-49 | (CH₂)₂C₆H₄CN | H | F | H | H | H |
| A-50 | (CH₂)₂C₆H₄CH₃ | H | F | H | H | H |
| A-51 | (CH₂)₂C₆H₄CF₃ | H | F | H | H | H |
| A-52 | (CH₂)₂C₆H₄OCH₃ | H | F | H | H | H |
| A-53 | (CH₂)₂C₆H₄OCF₃ | H | F | H | H | H |
| A-54 | CH₂CH═CH₂ | H | F | H | H | H |
| A-55 | cyclo-C₃H₅ | H | F | H | H | H |
| A-56 | (CH₂)₂NHCH₃ | H | F | H | H | H |
| A-57 | H | H | CF₃ | H | H | H |
| A-58 | CH₃ | CH₃ | CF₃ | H | H | H |
| A-59 | CH₂CH₃ | CH₂CH₃ | CF₃ | H | H | H |
| A-60 | CH₃ | H | CF₃ | H | H | H |
| A-61 | CH₂CH₃ | H | CF₃ | H | H | H |
| A-62 | (CH₂)₂CH₃ | H | CF₃ | H | H | H |
| A-63 | CH(CH₃)₂ | H | CF₃ | H | H | H |
| A-64 | CH₂CF₃ | H | CF₃ | H | H | H |
| A-65 | C(CH₃)₃ | H | CF₃ | H | H | H |
| A-66 | CH₂CH(CH₃)₂ | H | CF₃ | H | H | H |
| A-67 | CH(CH₃)CH₂CH₃ | H | CF₃ | H | H | H |
| A-68 | (CH₂)₂OCH₃ | H | CF₃ | H | H | H |
| A-69 | CH₂CH(OCH₃)₂ | H | CF₃ | H | H | H |
| A-70 | CH₂CH(OCH₂CH₃)₂ | H | CF₃ | H | H | H |
| A-71 | CH₂C₆H₅ | H | CF₃ | H | H | H |
| A-72 | CH(CH₃)C₆H₅ | H | CF₃ | H | H | H |
| A-73 | (CH₂)₂OC₆H₅ | H | CF₃ | H | H | H |
| A-74 | (CH₂)₂C₆H₅ | H | CF₃ | H | H | H |
| A-75 | (CH₂)₂C₆H₄F | H | CF₃ | H | H | H |
| A-76 | (CH₂)₂C₆H₄Cl | H | CF₃ | H | H | H |
| A-77 | (CH₂)₂C₆H₄CN | H | CF₃ | H | H | H |
| A-78 | (CH₂)₂C₆H₄CH₃ | H | CF₃ | H | H | H |
| A-79 | (CH₂)₂C₆H₄CF₃ | H | CF₃ | H | H | H |
| A-80 | (CH₂)₂C₆H₄OCH₃ | H | CF₃ | H | H | H |
| A-81 | (CH₂)₂C₆H₄OCF₃ | H | CF₃ | H | H | H |
| A-82 | CH₂CH═CH₂ | H | CF₃ | H | H | H |
| A-83 | cyclo-C₃H₅ | H | CF₃ | H | H | H |
| A-84 | (CH₂)₂NHCH₃ | H | CF₃ | H | H | H |
| A-85 | H | H | H | H | Cl | H |
| A-86 | CH₃ | CH₃ | H | H | Cl | H |
| A-87 | CH₂CH₃ | CH₂CH₃ | H | H | Cl | H |
| A-88 | CH₃ | H | H | H | Cl | H |
| A-89 | CH₂CH₃ | H | H | H | Cl | H |
| A-90 | (CH₂)₂CH₃ | H | H | H | Cl | H |
| A-91 | CH(CH₃)₂ | H | H | H | Cl | H |
| A-92 | CH₂CF₃ | H | H | H | Cl | H |
| A-93 | C(CH₃)₃ | H | H | H | Cl | H |
| A-94 | CH₂CH(CH₃)₂ | H | H | H | Cl | H |
| A-95 | CH(CH₃)CH₂CH₃ | H | H | H | Cl | H |
| A-96 | (CH₂)₂OCH₃ | H | H | H | Cl | H |
| A-97 | CH₂CH(OCH₃)₂ | H | H | H | Cl | H |
| A-98 | CH₂CH(OCH₂CH₃)₂ | H | H | H | Cl | H |
| A-99 | CH₂C₆H₅ | H | H | H | Cl | H |
| A-100 | CH(CH₃)C₆H₅ | H | H | H | Cl | H |
| A-101 | (CH₂)₂OC₆H₅ | H | H | H | Cl | H |
| A-102 | (CH₂)₂C₆H₅ | H | H | H | Cl | H |
| A-103 | (CH₂)₂C₆H₄F | H | H | H | Cl | H |
| A-104 | (CH₂)₂C₆H₄Cl | H | H | H | Cl | H |
| A-105 | (CH₂)₂C₆H₄CN | H | H | H | Cl | H |
| A-106 | (CH₂)₂C₆H₄CH₃ | H | H | H | Cl | H |
| A-107 | (CH₂)₂C₆H₄CF₃ | H | H | H | Cl | H |
| A-108 | (CH₂)₂C₆H₄OCH₃ | H | H | H | Cl | H |
| A-109 | (CH₂)₂C₆H₄OCF₃ | H | H | H | Cl | H |
| A-110 | CH₂CH═CH₂ | H | H | H | Cl | H |
| A-111 | cyclo-C₃H₅ | H | H | H | Cl | H |
| A-112 | (CH₂)₂NHCH₃ | H | H | H | Cl | H |
| A-113 | H | H | H | H | F | H |
| A-114 | CH₃ | CH₃ | H | H | F | H |
| A-115 | CH₂CH₃ | CH₂CH₃ | H | H | F | H |
| A-116 | CH₃ | H | H | H | F | H |
| A-117 | CH₂CH₃ | H | H | H | F | H |
| A-118 | (CH₂)₂CH₃ | H | H | H | F | H |
| A-119 | CH(CH₃)₂ | H | H | H | F | H |
| A-120 | CH₂CF₃ | H | H | H | F | H |
| A-121 | C(CH₃)₃ | H | H | H | F | H |
| A-122 | CH₂CH(CH₃)₂ | H | H | H | F | H |
| A-123 | CH(CH₃)CH₂CH₃ | H | H | H | F | H |
| A-124 | (CH₂)₂OCH₃ | H | H | H | F | H |
| A-125 | CH₂CH(OCH₃)₂ | H | H | H | F | H |
| A-126 | CH₂CH(OCH₂CH₃)₂ | H | H | H | F | H |
| A-127 | CH₂C₆H₅ | H | H | H | F | H |
| A-128 | CH(CH₃)C₆H₅ | H | H | H | F | H |
| A-129 | (CH₂)₂OC₆H₅ | H | H | H | F | H |
| A-130 | (CH₂)₂C₆H₅ | H | H | H | F | H |
| A-131 | (CH₂)₂C₆H₄F | H | H | H | F | H |
| A-132 | (CH₂)₂C₆H₄Cl | H | H | H | F | H |
| A-133 | (CH₂)₂C₆H₄CN | H | H | H | F | H |
| A-134 | (CH₂)₂C₆H₄CH₃ | H | H | H | F | H |
| A-135 | (CH₂)₂C₆H₄CF₃ | H | H | H | F | H |
| A-136 | (CH₂)₂C₆H₄OCH₃ | H | H | H | F | H |
| A-137 | (CH₂)₂C₆H₄OCF₃ | H | H | H | F | H |
| A-138 | CH₂CH═CH₂ | H | H | H | F | H |
| A-139 | cyclo-C₃H₅ | H | H | H | F | H |
| A-140 | (CH₂)₂NHCH₃ | H | H | H | F | H |
| A-141 | H | H | H | H | CF₃ | H |
| A-142 | CH₃ | CH₃ | H | H | CF₃ | H |
| A-143 | CH₂CH₃ | CH₂CH₃ | H | H | CF₃ | H |
| A-144 | CH₃ | H | H | H | CF₃ | H |
| A-145 | CH₂CH₃ | H | H | H | CF₃ | H |
| A-146 | (CH₂)₂CH₃ | H | H | H | CF₃ | H |
| A-147 | CH(CH₃)₂ | H | H | H | CF₃ | H |
| A-148 | CH₂CF₃ | H | H | H | CF₃ | H |
| A-149 | C(CH₃)₃ | H | H | H | CF₃ | H |
| A-150 | CH₂CH(CH₃)₂ | H | H | H | CF₃ | H |
| A-151 | CH(CH₃)CH₂CH₃ | H | H | H | CF₃ | H |
| A-152 | (CH₂)₂OCH₃ | H | H | H | CF₃ | H |
| A-153 | CH₂CH(OCH₃)₂ | H | H | H | CF₃ | H |
| A-154 | CH₂CH(OCH₂CH₃)₂ | H | H | H | CF₃ | H |
| A-155 | CH₂C₆H₅ | H | H | H | CF₃ | H |
| A-156 | CH(CH₃)C₆H₅ | H | H | H | CF₃ | H |
| A-157 | (CH₂)₂OC₆H₅ | H | H | H | CF₃ | H |
| A-158 | (CH₂)₂C₆H₅ | H | H | H | CF₃ | H |
| A-159 | (CH₂)₂C₆H₄F | H | H | H | CF₃ | H |
| A-160 | (CH₂)₂C₆H₄Cl | H | H | H | CF₃ | H |
| A-161 | (CH₂)₂C₆H₄CN | H | H | H | CF₃ | H |
| A-162 | (CH₂)₂C₆H₄CH₃ | H | H | H | CF₃ | H |
| A-163 | (CH₂)₂C₆H₄CF₃ | H | H | H | CF₃ | H |
| A-164 | (CH₂)₂C₆H₄OCH₃ | H | H | H | CF₃ | H |
| A-165 | (CH₂)₂C₆H₄OCF₃ | H | H | H | CF₃ | H |
| A-166 | CH₂CH═CH₂ | H | H | H | CF₃ | H |
| A-167 | cyclo-C₃H₅ | H | H | H | CF₃ | H |
| A-168 | (CH₂)₂NHCH₃ | H | H | H | CF₃ | H |
| A-169 | H | H | Cl | H | Cl | H |
| A-170 | CH₃ | CH₃ | Cl | H | Cl | H |
| A-171 | CH₂CH₃ | CH₂CH₃ | Cl | H | Cl | H |
| A-172 | CH₃ | H | Cl | H | Cl | H |
| A-173 | CH₂CH₃ | H | Cl | H | Cl | H |
| A-174 | (CH₂)₂CH₃ | H | Cl | H | Cl | H |
| A-175 | CH(CH₃)₂ | H | Cl | H | Cl | H |
| A-176 | CH₂CF₃ | H | Cl | H | Cl | H |
| A-177 | C(CH₃)₃ | H | Cl | H | Cl | H |
| A-178 | CH₂CH(CH₃)₂ | H | Cl | H | Cl | H |
| A-179 | CH(CH₃)CH₂CH₃ | H | Cl | H | Cl | H |
| A-180 | (CH₂)₂OCH₃ | H | Cl | H | Cl | H |
| A-181 | CH₂CH(OCH₃)₂ | H | Cl | H | Cl | H |
| A-182 | CH₂CH(OCH₂CH₃)₂ | H | Cl | H | Cl | H |
| A-183 | CH₂C₆H₅ | H | Cl | H | Cl | H |
| A-184 | CH(CH₃)C₆H₅ | H | Cl | H | Cl | H |
| A-185 | (CH₂)₂OC₆H₅ | H | Cl | H | Cl | H |
| A-186 | (CH₂)₂C₆H₅ | H | Cl | H | Cl | H |
| A-187 | (CH₂)₂C₆H₄F | H | Cl | H | Cl | H |
| A-188 | (CH₂)₂C₆H₄Cl | H | Cl | H | Cl | H |
| A-189 | (CH₂)₂C₆H₄CN | H | Cl | H | Cl | H |
| A-190 | (CH₂)₂C₆H₄CH₃ | H | Cl | H | Cl | H |
| A-191 | (CH₂)₂C₆H₄CF₃ | H | Cl | H | Cl | H |
| A-192 | (CH₂)₂C₆H₄OCH₃ | H | Cl | H | Cl | H |
| A-193 | (CH₂)₂C₆H₄OCF₃ | H | Cl | H | Cl | H |
| A-194 | CH₂CH═CH₂ | H | Cl | H | Cl | H |
| A-195 | cyclo-C₃H₅ | H | Cl | H | Cl | H |
| A-196 | (CH₂)₂NHCH₃ | H | Cl | H | Cl | H |
| A-197 | H | H | F | H | Cl | H |
| A-198 | CH₃ | CH₃ | F | H | Cl | H |
| A-199 | CH₂CH₃ | CH₂CH₃ | F | H | Cl | H |
| A-200 | CH₃ | H | F | H | Cl | H |
| A-201 | CH₂CH₃ | H | F | H | Cl | H |
| A-202 | (CH₂)₂CH₃ | H | F | H | Cl | H |
| A-203 | CH(CH₃)₂ | H | F | H | Cl | H |
| A-204 | CH₂CF₃ | H | F | H | Cl | H |
| A-205 | C(CH₃)₃ | H | F | H | Cl | H |
| A-206 | CH₂CH(CH₃)₂ | H | F | H | Cl | H |
| A-207 | CH(CH₃)CH₂CH₃ | H | F | H | Cl | H |
| A-208 | (CH₂)₂OCH₃ | H | F | H | Cl | H |
| A-209 | CH₂CH(OCH₃)₂ | H | F | H | Cl | H |
| A-210 | CH₂CH(OCH₂CH₃)₂ | H | F | H | Cl | H |
| A-211 | CH₂C₆H₅ | H | F | H | Cl | H |
| A-212 | CH(CH₃)C₆H₅ | H | F | H | Cl | H |
| A-213 | (CH₂)₂OC₆H₅ | H | F | H | Cl | H |
| A-214 | (CH₂)₂C₆H₅ | H | F | H | Cl | H |
| A-215 | (CH₂)₂C₆H₄F | H | F | H | Cl | H |
| A-216 | (CH₂)₂C₆H₄Cl | H | F | H | Cl | H |
| A-217 | (CH₂)₂C₆H₄CN | H | F | H | Cl | H |
| A-218 | (CH₂)₂C₆H₄CH₃ | H | F | H | Cl | H |
| A-219 | (CH₂)₂C₆H₄CF₃ | H | F | H | Cl | H |
| A-220 | (CH₂)₂C₆H₄OCH₃ | H | F | H | Cl | H |
| A-221 | (CH₂)₂C₆H₄OCF₃ | H | F | H | Cl | H |
| A-222 | CH₂CH═CH₂ | H | F | H | Cl | H |
| A-223 | cyclo-C₃H₅ | H | F | H | Cl | H |
| A-224 | (CH₂)₂NHCH₃ | H | F | H | Cl | H |
| A-225 | H | H | Cl | H | F | H |
| A-226 | CH₃ | CH₃ | Cl | H | F | H |
| A-227 | CH₂CH₃ | CH₂CH₃ | Cl | H | F | H |
| A-228 | CH₃ | H | Cl | H | F | H |
| A-229 | CH₂CH₃ | H | Cl | H | F | H |
| A-230 | (CH₂)₂CH₃ | H | Cl | H | F | H |
| A-231 | CH(CH₃)₂ | H | Cl | H | F | H |
| A-232 | CH₂CF₃ | H | Cl | H | F | H |
| A-233 | C(CH₃)₃ | H | Cl | H | F | H |
| A-234 | CH₂CH(CH₃)₂ | H | Cl | H | F | H |
| A-235 | CH(CH₃)CH₂CH₃ | H | Cl | H | F | H |
| A-236 | (CH₂)₂OCH₃ | H | Cl | H | F | H |
| A-237 | CH₂CH(OCH₃)₂ | H | Cl | H | F | H |
| A-238 | CH₂CH(OCH₂CH₃)₂ | H | Cl | H | F | H |
| A-239 | CH₂C₆H₅ | H | Cl | H | F | H |
| A-240 | CH(CH₃)C₆H₅ | H | Cl | H | F | H |
| A-241 | (CH₂)₂OC₆H₅ | H | Cl | H | F | H |
| A-242 | (CH₂)₂C₆H₅ | H | Cl | H | F | H |
| A-243 | (CH₂)₂C₆H₄F | H | Cl | H | F | H |
| A-244 | (CH₂)₂C₆H₄Cl | H | Cl | H | F | H |
| A-245 | (CH₂)₂C₆H₄CN | H | Cl | H | F | H |
| A-246 | (CH₂)₂C₆H₄CH₃ | H | Cl | H | F | H |
| A-247 | (CH₂)₂C₆H₄CF₃ | H | Cl | H | F | H |
| A-248 | (CH₂)₂C₆H₄OCH₃ | H | Cl | H | F | H |
| A-249 | (CH₂)₂C₆H₄OCF₃ | H | Cl | H | F | H |
| A-250 | CH₂CH═CH₂ | H | Cl | H | F | H |
| A-251 | cyclo-C₃H₅ | H | Cl | H | F | H |
| A-252 | (CH₂)₂NHCH₃ | H | Cl | H | F | H |
| A-253 | H | H | F | H | F | H |
| A-254 | CH₃ | CH₃ | F | H | F | H |
| A-255 | CH₂CH₃ | CH₂CH₃ | F | H | F | H |
| A-256 | CH₃ | H | F | H | F | H |
| A-257 | CH₂CH₃ | H | F | H | F | H |
| A-258 | (CH₂)₂CH₃ | H | F | H | F | H |
| A-259 | CH(CH₃)₂ | H | F | H | F | H |
| A-260 | CH₂CF₃ | H | F | H | F | H |
| A-261 | C(CH₃)₃ | H | F | H | F | H |
| A-262 | CH₂CH(CH₃)₂ | H | F | H | F | H |
| A-263 | CH(CH₃)CH₂CH₃ | H | F | H | F | H |
| A-264 | (CH₂)₂OCH₃ | H | F | H | F | H |
| A-265 | CH₂CH(OCH₃)₂ | H | F | H | F | H |
| A-266 | CH₂CH(OCH₂CH₃)₂ | H | F | H | F | H |
| A-267 | CH₂C₆H₅ | H | F | H | F | H |
| A-268 | CH(CH₃)C₆H₅ | H | F | H | F | H |
| A-269 | (CH₂)₂OC₆H₅ | H | F | H | F | H |
| A-270 | (CH₂)₂C₆H₅ | H | F | H | F | H |
| A-271 | (CH₂)₂C₆H₄F | H | F | H | F | H |
| A-272 | (CH₂)₂C₆H₄Cl | H | F | H | F | H |
| A-273 | (CH₂)₂C₆H₄CN | H | F | H | F | H |
| A-274 | (CH₂)₂C₆H₄CH₃ | H | F | H | F | H |
| A-275 | (CH₂)₂C₆H₄CF₃ | H | F | H | F | H |
| A-276 | (CH₂)₂C₆H₄OCH₃ | H | F | H | F | H |
| A-277 | (CH₂)₂C₆H₄OCF₃ | H | F | H | F | H |
| A-278 | CH₂CH═CH₂ | H | F | H | F | H |
| A-279 | cyclo-C₃H₅ | H | F | H | F | H |
| A-280 | (CH₂)₂NHCH₃ | H | F | H | F | H |
| A-281 | H | H | Cl | H | CF₃ | H |
| A-282 | CH₃ | CH₃ | Cl | H | CF₃ | H |
| A-283 | CH₂CH₃ | CH₂CH₃ | Cl | H | CF₃ | H |
| A-284 | CH₃ | H | Cl | H | CF₃ | H |
| A-285 | CH₂CH₃ | H | Cl | H | CF₃ | H |
| A-286 | (CH₂)₂CH₃ | H | Cl | H | CF₃ | H |
| A-287 | CH(CH₃)₂ | H | Cl | H | CF₃ | H |
| A-288 | CH₂CF₃ | H | Cl | H | CF₃ | H |
| A-289 | C(CH₃)₃ | H | Cl | H | CF₃ | H |
| A-290 | CH₂CH(CH₃)₂ | H | Cl | H | CF₃ | H |
| A-291 | CH(CH₃)CH₂CH₃ | H | Cl | H | CF₃ | H |
| A-292 | (CH₂)₂OCH₃ | H | Cl | H | CF₃ | H |
| A-293 | CH₂CH(OCH₃)₂ | H | Cl | H | CF₃ | H |
| A-294 | CH₂CH(OCH₂CH₃)₂ | H | Cl | H | CF₃ | H |
| A-295 | CH₂C₆H₅ | H | Cl | H | CF₃ | H |
| A-296 | CH(CH₃)C₆H₅ | H | Cl | H | CF₃ | H |
| A-297 | (CH₂)₂OC₆H₅ | H | Cl | H | CF₃ | H |
| A-298 | (CH₂)₂C₆H₅ | H | Cl | H | CF₃ | H |
| A-299 | (CH₂)₂C₆H₄F | H | Cl | H | CF₃ | H |
| A-300 | (CH₂)₂C₆H₄Cl | H | Cl | H | CF₃ | H |
| A-301 | (CH₂)₂C₆H₄CN | H | Cl | H | CF₃ | H |
| A-302 | (CH₂)₂C₆H₄CH₃ | H | Cl | H | CF₃ | H |
| A-303 | (CH₂)₂C₆H₄CF₃ | H | Cl | H | CF₃ | H |
| A-304 | (CH₂)₂C₆H₄OCH₃ | H | Cl | H | CF₃ | H |
| A-305 | (CH₂)₂C₆H₄OCF₃ | H | Cl | H | CF₃ | H |
| A-306 | CH₂CH═CH₂ | H | Cl | H | CF₃ | H |
| A-307 | cyclo-C₃H₅ | H | Cl | H | CF₃ | H |
| A-308 | (CH₂)₂NHCH₃ | H | Cl | H | CF₃ | H |
| A-309 | H | H | CF₃ | H | Cl | H |
| A-310 | CH₃ | CH₃ | CF₃ | H | Cl | H |
| A-311 | CH₂CH₃ | CH₂CH₃ | CF₃ | H | Cl | H |
| A-312 | CH₃ | H | CF₃ | H | Cl | H |
| A-313 | CH₂CH₃ | H | CF₃ | H | Cl | H |
| A-314 | (CH₂)₂CH₃ | H | CF₃ | H | Cl | H |
| A-315 | CH(CH₃)₂ | H | CF₃ | H | Cl | H |
| A-316 | CH₂CF₃ | H | CF₃ | H | Cl | H |
| A-317 | C(CH₃)₃ | H | CF₃ | H | Cl | H |
| A-318 | CH₂CH(CH₃)₂ | H | CF₃ | H | Cl | H |
| A-319 | CH(CH₃)CH₂CH₃ | H | CF₃ | H | Cl | H |
| A-320 | (CH₂)₂OCH₃ | H | CF₃ | H | Cl | H |
| A-321 | CH₂CH(OCH₃)₂ | H | CF₃ | H | Cl | H |
| A-322 | CH₂CH(OCH₂CH₃)₂ | H | CF₃ | H | Cl | H |
| A-323 | CH₂C₆H₅ | H | CF₃ | H | Cl | H |
| A-324 | CH(CH₃)C₆H₅ | H | CF₃ | H | Cl | H |
| A-325 | (CH₂)₂OC₆H₅ | H | CF₃ | H | Cl | H |
| A-326 | (CH₂)₂C₆H₅ | H | CF₃ | H | Cl | H |
| A-327 | (CH₂)₂C₆H₄F | H | CF₃ | H | Cl | H |
| A-328 | (CH₂)₂C₆H₄Cl | H | CF₃ | H | Cl | H |
| A-329 | (CH₂)₂C₆H₄CN | H | CF₃ | H | Cl | H |
| A-330 | (CH₂)₂C₆H₄CH₃ | H | CF₃ | H | Cl | H |
| A-331 | (CH₂)₂C₆H₄CF₃ | H | CF₃ | H | Cl | H |
| A-332 | (CH₂)₂C₆H₄OCH₃ | H | CF₃ | H | Cl | H |
| A-333 | (CH₂)₂C₆H₄OCF₃ | H | CF₃ | H | Cl | H |
| A-334 | CH₂CH═CH₂ | H | CF₃ | H | Cl | H |
| A-335 | cyclo-C₃H₅ | H | CF₃ | H | Cl | H |
| A-336 | (CH₂)₂NHCH₃ | H | CF₃ | H | Cl | H |
| A-337 | H | H | F | H | CF₃ | H |
| A-338 | CH₃ | CH₃ | F | H | CF₃ | H |
| A-339 | CH₂CH₃ | CH₂CH₃ | F | H | CF₃ | H |
| A-340 | CH₃ | H | F | H | CF₃ | H |
| A-341 | CH₂CH₃ | H | F | H | CF₃ | H |
| A-342 | (CH₂)₂CH₃ | H | F | H | CF₃ | H |
| A-343 | CH(CH₃)₂ | H | F | H | CF₃ | H |
| A-344 | CH₂CF₃ | H | F | H | CF₃ | H |
| A-345 | C(CH₃)₃ | H | F | H | CF₃ | H |
| A-346 | CH₂CH(CH₃)₂ | H | F | H | CF₃ | H |
| A-347 | CH(CH₃)CH₂CH₃ | H | F | H | CF₃ | H |
| A-348 | (CH₂)₂OCH₃ | H | F | H | CF₃ | H |
| A-349 | CH₂CH(OCH₃)₂ | H | F | H | CF₃ | H |
| A-350 | CH₂CH(OCH₂CH₃)₂ | H | F | H | CF₃ | H |
| A-351 | CH₂C₆H₅ | H | F | H | CF₃ | H |
| A-352 | CH(CH₃)C₆H₅ | H | F | H | CF₃ | H |
| A-353 | (CH₂)₂OC₆H₅ | H | F | H | CF₃ | H |
| A-354 | (CH₂)₂C₆H₅ | H | F | H | CF₃ | H |
| A-355 | (CH₂)₂C₆H₄F | H | F | H | CF₃ | H |
| A-356 | (CH₂)₂C₆H₄Cl | H | F | H | CF₃ | H |
| A-357 | (CH₂)₂C₆H₄CN | H | F | H | CF₃ | H |
| A-358 | (CH₂)₂C₆H₄CH₃ | H | F | H | CF₃ | H |
| A-359 | (CH₂)₂C₆H₄CF₃ | H | F | H | CF₃ | H |
| A-360 | (CH₂)₂C₆H₄OCH₃ | H | F | H | CF₃ | H |
| A-361 | (CH₂)₂C₆H₄OCF₃ | H | F | H | CF₃ | H |
| A-362 | CH₂CH═CH₂ | H | F | H | CF₃ | H |
| A-363 | cyclo-C₃H₅ | H | F | H | CF₃ | H |
| A-364 | (CH₂)₂NHCH₃ | H | F | H | CF₃ | H |
| A-365 | H | H | CF₃ | H | F | H |
| A-366 | CH₃ | CH₃ | CF₃ | H | F | H |
| A-367 | CH₂CH₃ | CH₂CH₃ | CF₃ | H | F | H |
| A-368 | CH₃ | H | CF₃ | H | F | H |
| A-369 | CH₂CH₃ | H | CF₃ | H | F | H |
| A-370 | (CH₂)₂CH₃ | H | CF₃ | H | F | H |
| A-371 | CH(CH₃)₂ | H | CF₃ | H | F | H |
| A-372 | CH₂CF₃ | H | CF₃ | H | F | H |
| A-373 | C(CH₃)₃ | H | CF₃ | H | F | H |
| A-374 | CH₂CH(CH₃)₂ | H | CF₃ | H | F | H |
| A-375 | CH(CH₃)CH₂CH₃ | H | CF₃ | H | F | H |
| A-376 | (CH₂)₂OCH₃ | H | CF₃ | H | F | H |
| A-377 | CH₂CH(OCH₃)₂ | H | CF₃ | H | F | H |
| A-378 | CH₂CH(OCH₂CH₃)₂ | H | CF₃ | H | F | H |
| A-379 | CH₂C₆H₅ | H | CF₃ | H | F | H |
| A-380 | CH(CH₃)C₆H₅ | H | CF₃ | H | F | H |
| A-381 | (CH₂)₂OC₆H₅ | H | CF₃ | H | F | H |
| A-382 | (CH₂)₂C₆H₅ | H | CF₃ | H | F | H |
| A-383 | (CH₂)₂C₆H₄F | H | CF₃ | H | F | H |
| A-384 | (CH₂)₂C₆H₄Cl | H | CF₃ | H | F | H |
| A-385 | (CH₂)₂C₆H₄CN | H | CF₃ | H | F | H |
| A-386 | (CH₂)₂C₆H₄CH₃ | H | CF₃ | H | F | H |
| A-387 | (CH₂)₂C₆H₄CF₃ | H | CF₃ | H | F | H |
| A-388 | (CH₂)₂C₆H₄OCH₃ | H | CF₃ | H | F | H |
| A-389 | (CH₂)₂C₆H₄OCF₃ | H | CF₃ | H | F | H |
| A-390 | CH₂CH═CH₂ | H | CF₃ | H | F | H |
| A-391 | cyclo-C₃H₅ | H | CF₃ | H | F | H |
| A-392 | (CH₂)₂NHCH₃ | H | CF₃ | H | F | H |
| A-393 | H | H | CF₃ | H | CF₃ | H |
| A-394 | CH₃ | CH₃ | CF₃ | H | CF₃ | H |
| A-395 | CH₂CH₃ | CH₂CH₃ | CF₃ | H | CF₃ | H |
| A-396 | CH₃ | H | CF₃ | H | CF₃ | H |
| A-397 | CH₂CH₃ | H | CF₃ | H | CF₃ | H |
| A-398 | (CH₂)₂CH₃ | H | CF₃ | H | CF₃ | H |
| A-399 | CH(CH₃)₂ | H | CF₃ | H | CF₃ | H |
| A-400 | CH₂CF₃ | H | CF₃ | H | CF₃ | H |
| A-401 | C(CH₃)₃ | H | CF₃ | H | CF₃ | H |
| A-402 | CH₂CH(CH₃)₂ | H | CF₃ | H | CF₃ | H |
| A-403 | CH(CH₃)CH₂CH₃ | H | CF₃ | H | CF₃ | H |
| A-404 | (CH₂)₂OCH₃ | H | CF₃ | H | CF₃ | H |
| A-405 | CH₂CH(OCH₃)₂ | H | CF₃ | H | CF₃ | H |
| A-406 | CH₂CH(OCH₂CH₃)₂ | H | CF₃ | H | CF₃ | H |
| A-407 | CH₂C₆H₅ | H | CF₃ | H | CF₃ | H |
| A-408 | CH(CH₃)C₆H₅ | H | CF₃ | H | CF₃ | H |
| A-409 | (CH₂)₂OC₆H₅ | H | CF₃ | H | CF₃ | H |
| A-410 | (CH₂)₂C₆H₅ | H | CF₃ | H | CF₃ | H |
| A-411 | (CH₂)₂C₆H₄F | H | CF₃ | H | CF₃ | H |
| A-412 | (CH₂)₂C₆H₄Cl | H | CF₃ | H | CF₃ | H |
| A-413 | (CH₂)₂C₆H₄CN | H | CF₃ | H | CF₃ | H |
| A-414 | (CH₂)₂C₆H₄CH₃ | H | CF₃ | H | CF₃ | H |
| A-415 | (CH₂)₂C₆H₄CF₃ | H | CF₃ | H | CF₃ | H |
| A-416 | (CH₂)₂C₆H₄OCH₃ | H | CF₃ | H | CF₃ | H |
| A-417 | (CH₂)₂C₆H₄OCF₃ | H | CF₃ | H | CF₃ | H |
| A-418 | CH₂CH═CH₂ | H | CF₃ | H | CF₃ | H |
| A-419 | cyclo-C₃H₅ | H | CF₃ | H | CF₃ | H |
| A-420 | (CH₂)₂NHCH₃ | H | CF₃ | H | CF₃ | H |
| A-421 | H | H | Cl | Cl | Cl | H |
| A-422 | CH₃ | CH₃ | Cl | Cl | Cl | H |
| A-423 | CH₂CH₃ | CH₂CH₃ | Cl | Cl | Cl | H |
| A-424 | CH₃ | H | Cl | Cl | Cl | H |
| A-425 | CH₂CH₃ | H | Cl | Cl | Cl | H |
| A-426 | (CH₂)₂CH₃ | H | Cl | Cl | Cl | H |
| A-427 | CH(CH₃)₂ | H | Cl | Cl | Cl | H |
| A-428 | CH₂CF₃ | H | Cl | Cl | Cl | H |
| A-429 | C(CH₃)₃ | H | Cl | Cl | Cl | H |
| A-430 | CH₂CH(CH₃)₂ | H | Cl | Cl | Cl | H |
| A-431 | CH(CH₃)CH₂CH₃ | H | Cl | Cl | Cl | H |
| A-432 | (CH₂)₂OCH₃ | H | Cl | Cl | Cl | H |
| A-433 | CH₂CH(OCH₃)₂ | H | Cl | Cl | Cl | H |
| A-434 | CH₂CH(OCH₂CH₃)₂ | H | Cl | Cl | Cl | H |
| A-435 | CH₂C₆H₅ | H | Cl | Cl | Cl | H |
| A-436 | CH(CH₃)C₆H₅ | H | Cl | Cl | Cl | H |
| A-437 | (CH₂)₂OC₆H₅ | H | Cl | Cl | Cl | H |
| A-438 | (CH₂)₂C₆H₅ | H | Cl | Cl | Cl | H |
| A-439 | (CH₂)₂C₆H₄F | H | Cl | Cl | Cl | H |
| A-440 | (CH₂)₂C₆H₄Cl | H | Cl | Cl | Cl | H |
| A-441 | (CH₂)₂C₆H₄CN | H | Cl | Cl | Cl | H |
| A-442 | (CH₂)₂C₆H₄CH₃ | H | Cl | Cl | Cl | H |
| A-443 | (CH₂)₂C₆H₄CF₃ | H | Cl | Cl | Cl | H |
| A-444 | (CH₂)₂C₆H₄OCH₃ | H | Cl | Cl | Cl | H |
| A-445 | (CH₂)₂C₆H₄OCF₃ | H | Cl | Cl | Cl | H |
| A-446 | CH₂CH═CH₂ | H | Cl | Cl | Cl | H |
| A-447 | cyclo-C₃H₅ | H | Cl | Cl | Cl | H |
| A-448 | (CH₂)₂NHCH₃ | H | Cl | Cl | Cl | H |
| A-449 | H | H | Cl | F | Cl | H |
| A-450 | CH₃ | CH₃ | Cl | F | Cl | H |
| A-451 | CH₂CH₃ | CH₂CH₃ | Cl | F | Cl | H |
| A-452 | CH₃ | H | Cl | F | Cl | H |
| A-453 | CH₂CH₃ | H | Cl | F | Cl | H |
| A-454 | (CH₂)₂CH₃ | H | Cl | F | Cl | H |
| A-455 | CH(CH₃)₂ | H | Cl | F | Cl | H |
| A-456 | CH₂CF₃ | H | Cl | F | Cl | H |
| A-457 | C(CH₃)₃ | H | Cl | F | Cl | H |
| A-458 | CH₂CH(CH₃)₂ | H | Cl | F | Cl | H |
| A-459 | CH(CH₃)CH₂CH₃ | H | Cl | F | Cl | H |
| A-460 | (CH₂)₂OCH₃ | H | Cl | F | Cl | H |
| A-461 | CH₂CH(OCH₃)₂ | H | Cl | F | Cl | H |
| A-462 | CH₂CH(OCH₂CH₃)₂ | H | Cl | F | Cl | H |
| A-463 | CH₂C₆H₅ | H | Cl | F | Cl | H |
| A-464 | CH(CH₃)C₆H₅ | H | Cl | F | Cl | H |
| A-465 | (CH₂)₂OC₆H₅ | H | Cl | F | Cl | H |
| A-466 | (CH₂)₂C₆H₅ | H | Cl | F | Cl | H |
| A-467 | (CH₂)₂C₆H₄F | H | Cl | F | Cl | H |
| A-468 | (CH₂)₂C₆H₄Cl | H | Cl | F | Cl | H |
| A-469 | (CH₂)₂C₆H₄CN | H | Cl | F | Cl | H |
| A-470 | (CH₂)₂C₆H₄CH₃ | H | Cl | F | Cl | H |
| A-471 | (CH₂)₂C₆H₄CF₃ | H | Cl | F | Cl | H |
| A-472 | (CH₂)₂C₆H₄OCH₃ | H | Cl | F | Cl | H |
| A-473 | (CH₂)₂C₆H₄OCF₃ | H | Cl | F | Cl | H |
| A-474 | CH₂CH═CH₂ | H | Cl | F | Cl | H |
| A-475 | cyclo-C₃H₅ | H | Cl | F | Cl | H |
| A-476 | (CH₂)₂NHCH₃ | H | Cl | F | Cl | H |
| A-477 | H | H | Cl | Cl | F | H |
| A-478 | CH₃ | CH₃ | Cl | Cl | F | H |
| A-479 | CH₂CH₃ | CH₂CH₃ | Cl | Cl | F | H |
| A-480 | CH₃ | H | Cl | Cl | F | H |
| A-481 | CH₂CH₃ | H | Cl | Cl | F | H |
| A-482 | (CH₂)₂CH₃ | H | Cl | Cl | F | H |
| A-483 | CH(CH₃)₂ | H | Cl | Cl | F | H |
| A-484 | CH₂CF₃ | H | Cl | Cl | F | H |
| A-485 | C(CH₃)₃ | H | Cl | Cl | F | H |
| A-486 | CH₂CH(CH₃)₂ | H | Cl | Cl | F | H |
| A-487 | CH(CH₃)CH₂CH₃ | H | Cl | Cl | F | H |
| A-488 | (CH₂)₂OCH₃ | H | Cl | Cl | F | H |
| A-489 | CH₂CH(OCH₃)₂ | H | Cl | Cl | F | H |
| A-490 | CH₂CH(OCH₂CH₃)₂ | H | Cl | Cl | F | H |
| A-491 | CH₂C₆H₅ | H | Cl | Cl | F | H |
| A-492 | CH(CH₃)C₆H₅ | H | Cl | Cl | F | H |
| A-493 | (CH₂)₂OC₆H₅ | H | Cl | Cl | F | H |
| A-494 | (CH₂)₂C₆H₅ | H | Cl | Cl | F | H |
| A-495 | (CH₂)₂C₆H₄F | H | Cl | Cl | F | H |
| A-496 | (CH₂)₂C₆H₄Cl | H | Cl | Cl | F | H |
| A-497 | (CH₂)₂C₆H₄CN | H | Cl | Cl | F | H |
| A-498 | (CH₂)₂C₆H₄CH₃ | H | Cl | Cl | F | H |
| A-499 | (CH₂)₂C₆H₄CF₃ | H | Cl | Cl | F | H |
| A-500 | (CH₂)₂C₆H₄OCH₃ | H | Cl | Cl | F | H |
| A-501 | (CH₂)₂C₆H₄OCF₃ | H | Cl | Cl | F | H |
| A-502 | CH₂CH═CH₂ | H | Cl | Cl | F | H |
| A-503 | cyclo-C₃H₅ | H | Cl | Cl | F | H |
| A-504 | (CH₂)₂NHCH₃ | H | Cl | Cl | F | H |
| A-505 | H | H | F | Cl | Cl | H |
| A-506 | CH₃ | CH₃ | F | Cl | Cl | H |
| A-507 | CH₂CH₃ | CH₂CH₃ | F | Cl | Cl | H |
| A-508 | CH₃ | H | F | Cl | Cl | H |
| A-509 | CH₂CH₃ | H | F | Cl | Cl | H |
| A-510 | (CH₂)₂CH₃ | H | F | Cl | Cl | H |
| A-511 | CH(CH₃)₂ | H | F | Cl | Cl | H |
| A-512 | CH₂CF₃ | H | F | Cl | Cl | H |
| A-513 | C(CH₃)₃ | H | F | Cl | Cl | H |
| A-514 | CH₂CH(CH₃)₂ | H | F | Cl | Cl | H |
| A-515 | CH(CH₃)CH₂CH₃ | H | F | Cl | Cl | H |
| A-516 | (CH₂)₂OCH₃ | H | F | Cl | Cl | H |
| A-517 | CH₂CH(OCH₃)₂ | H | F | Cl | Cl | H |
| A-518 | CH₂CH(OCH₂CH₃)₂ | H | F | Cl | Cl | H |
| A-519 | CH₂C₆H₅ | H | F | Cl | Cl | H |
| A-520 | CH(CH₃)C₆H₅ | H | F | Cl | Cl | H |
| A-521 | (CH₂)₂OC₆H₅ | H | F | Cl | Cl | H |
| A-522 | (CH₂)₂C₆H₅ | H | F | Cl | Cl | H |
| A-523 | (CH₂)₂C₆H₄F | H | F | Cl | Cl | H |
| A-524 | (CH₂)₂C₆H₄Cl | H | F | Cl | Cl | H |
| A-525 | (CH₂)₂C₆H₄CN | H | F | Cl | Cl | H |
| A-526 | (CH₂)₂C₆H₄CH₃ | H | F | Cl | Cl | H |
| A-527 | (CH₂)₂C₆H₄CF₃ | H | F | Cl | Cl | H |
| A-528 | (CH₂)₂C₆H₄OCH₃ | H | F | Cl | Cl | H |
| A-529 | (CH₂)₂C₆H₄OCF₃ | H | F | Cl | Cl | H |
| A-530 | CH₂CH═CH₂ | H | F | Cl | Cl | H |
| A-531 | cyclo-C₃H₅ | H | F | Cl | Cl | H |
| A-532 | (CH₂)₂NHCH₃ | H | F | Cl | Cl | H |
| A-533 | H | H | F | F | Cl | H |
| A-534 | CH₃ | CH₃ | F | F | Cl | H |
| A-535 | CH₂CH₃ | CH₂CH₃ | F | F | Cl | H |
| A-536 | CH₃ | H | F | F | Cl | H |
| A-537 | CH₂CH₃ | H | F | F | Cl | H |
| A-538 | (CH₂)₂CH₃ | H | F | F | Cl | H |
| A-539 | CH(CH₃)₂ | H | F | F | Cl | H |
| A-540 | CH₂CF₃ | H | F | F | Cl | H |
| A-541 | C(CH₃)₃ | H | F | F | Cl | H |
| A-542 | CH₂CH(CH₃)₂ | H | F | F | Cl | H |
| A-543 | CH(CH₃)CH₂CH₃ | H | F | F | Cl | H |
| A-544 | (CH₂)₂OCH₃ | H | F | F | Cl | H |
| A-545 | CH₂CH(OCH₃)₂ | H | F | F | Cl | H |
| A-546 | CH₂CH(OCH₂CH₃)₂ | H | F | F | Cl | H |
| A-547 | CH₂C₆H₅ | H | F | F | Cl | H |
| A-548 | CH(CH₃)C₆H₅ | H | F | F | Cl | H |
| A-549 | (CH₂)₂OC₆H₅ | H | F | F | Cl | H |
| A-550 | (CH₂)₂C₆H₅ | H | F | F | Cl | H |
| A-551 | (CH₂)₂C₆H₄F | H | F | F | Cl | H |
| A-552 | (CH₂)₂C₆H₄Cl | H | F | F | Cl | H |
| A-553 | (CH₂)₂C₆H₄CN | H | F | F | Cl | H |
| A-554 | (CH₂)₂C₆H₄CH₃ | H | F | F | Cl | H |
| A-555 | (CH₂)₂C₆H₄CF₃ | H | F | F | Cl | H |
| A-556 | (CH₂)₂C₆H₄OCH₃ | H | F | F | Cl | H |
| A-557 | (CH₂)₂C₆H₄OCF₃ | H | F | F | Cl | H |
| A-558 | CH₂CH═CH₂ | H | F | F | Cl | H |
| A-559 | cyclo-C₃H₅ | H | F | F | Cl | H |
| A-560 | (CH₂)₂NHCH₃ | H | F | F | Cl | H |
| A-561 | H | H | F | Cl | F | H |
| A-562 | CH₃ | CH₃ | F | Cl | F | H |
| A-563 | CH₂CH₃ | CH₂CH₃ | F | Cl | F | H |
| A-564 | CH₃ | H | F | Cl | F | H |
| A-565 | CH₂CH₃ | H | F | Cl | F | H |
| A-566 | (CH₂)₂CH₃ | H | F | Cl | F | H |
| A-567 | CH(CH₃)₂ | H | F | Cl | F | H |
| A-568 | CH₂CF₃ | H | F | Cl | F | H |
| A-569 | C(CH₃)₃ | H | F | Cl | F | H |
| A-570 | CH₂CH(CH₃)₂ | H | F | Cl | F | H |
| A-571 | CH(CH₃)CH₂CH₃ | H | F | Cl | F | H |
| A-572 | (CH₂)₂OCH₃ | H | F | Cl | F | H |
| A-573 | CH₂CH(OCH₃)₂ | H | F | Cl | F | H |
| A-574 | CH₂CH(OCH₂CH₃)₂ | H | F | Cl | F | H |
| A-575 | CH₂C₆H₅ | H | F | Cl | F | H |
| A-576 | CH(CH₃)C₆H₅ | H | F | Cl | F | H |
| A-577 | (CH₂)₂OC₆H₅ | H | F | Cl | F | H |
| A-578 | (CH₂)₂C₆H₅ | H | F | Cl | F | H |
| A-579 | (CH₂)₂C₆H₄F | H | F | Cl | F | H |
| A-580 | (CH₂)₂C₆H₄Cl | H | F | Cl | F | H |
| A-581 | (CH₂)₂C₆H₄CN | H | F | Cl | F | H |
| A-582 | (CH₂)₂C₆H₄CH₃ | H | F | Cl | F | H |
| A-583 | (CH₂)₂C₆H₄CF₃ | H | F | Cl | F | H |
| A-584 | (CH₂)₂C₆H₄OCH₃ | H | F | Cl | F | H |
| A-585 | (CH₂)₂C₆H₄OCF₃ | H | F | Cl | F | H |
| A-586 | CH₂CH═CH₂ | H | F | Cl | F | H |
| A-587 | cyclo-C₃H₅ | H | F | Cl | F | H |
| A-588 | (CH₂)₂NHCH₃ | H | F | Cl | F | H |
| A-589 | H | H | Cl | F | F | H |
| A-590 | CH₃ | CH₃ | Cl | F | F | H |
| A-591 | CH₂CH₃ | CH₂CH₃ | Cl | F | F | H |
| A-592 | CH₃ | H | Cl | F | F | H |
| A-593 | CH₂CH₃ | H | Cl | F | F | H |
| A-594 | (CH₂)₂CH₃ | H | Cl | F | F | H |
| A-595 | CH(CH₃)₂ | H | Cl | F | F | H |
| A-596 | CH₂CF₃ | H | Cl | F | F | H |
| A-597 | C(CH₃)₃ | H | Cl | F | F | H |
| A-598 | CH₂CH(CH₃)₂ | H | Cl | F | F | H |
| A-599 | CH(CH₃)CH₂CH₃ | H | Cl | F | F | H |
| A-600 | (CH₂)₂OCH₃ | H | Cl | F | F | H |
| A-601 | CH₂CH(OCH₃)₂ | H | Cl | F | F | H |
| A-602 | CH₂CH(OCH₂CH₃)₂ | H | Cl | F | F | H |
| A-603 | CH₂C₆H₅ | H | Cl | F | F | H |
| A-604 | CH(CH₃)C₆H₅ | H | Cl | F | F | H |
| A-605 | (CH₂)₂OC₆H₅ | H | Cl | F | F | H |
| A-606 | (CH₂)₂C₆H₅ | H | Cl | F | F | H |
| A-607 | (CH₂)₂C₆H₄F | H | Cl | F | F | H |
| A-608 | (CH₂)₂C₆H₄Cl | H | Cl | F | F | H |
| A-609 | (CH₂)₂C₆H₄CN | H | Cl | F | F | H |
| A-610 | (CH₂)₂C₆H₄CH₃ | H | Cl | F | F | H |
| A-611 | (CH₂)₂C₆H₄CF₃ | H | Cl | F | F | H |
| A-612 | (CH₂)₂C₆H₄OCH₃ | H | Cl | F | F | H |
| A-613 | (CH₂)₂C₆H₄OCF₃ | H | Cl | F | F | H |
| A-614 | CH₂CH═CH₂ | H | Cl | F | F | H |
| A-615 | cyclo-C₃H₅ | H | Cl | F | F | H |
| A-616 | (CH₂)₂NHCH₃ | H | Cl | F | F | H |
| A-617 | H | H | F | F | F | H |
| A-618 | CH₃ | CH₃ | F | F | F | H |
| A-619 | CH₂CH₃ | CH₂CH₃ | F | F | F | H |
| A-620 | CH₃ | H | F | F | F | H |
| A-621 | CH₂CH₃ | H | F | F | F | H |
| A-622 | (CH₂)₂CH₃ | H | F | F | F | H |
| A-623 | CH(CH₃)₂ | H | F | F | F | H |
| A-624 | CH₂CF₃ | H | F | F | F | H |
| A-625 | C(CH₃)₃ | H | F | F | F | H |
| A-626 | CH₂CH(CH₃)₂ | H | F | F | F | H |
| A-627 | CH(CH₃)CH₂CH₃ | H | F | F | F | H |
| A-628 | (CH₂)₂OCH₃ | H | F | F | F | H |
| A-629 | CH₂CH(OCH₃)₂ | H | F | F | F | H |
| A-630 | CH₂CH(OCH₂CH₃)₂ | H | F | F | F | H |
| A-631 | CH₂C₆H₅ | H | F | F | F | H |
| A-632 | CH(CH₃)C₆H₅ | H | F | F | F | H |
| A-633 | (CH₂)₂OC₆H₅ | H | F | F | F | H |
| A-634 | (CH₂)₂C₆H₅ | H | F | F | F | H |
| A-635 | (CH₂)₂C₆H₄F | H | F | F | F | H |
| A-636 | (CH₂)₂C₆H₄Cl | H | F | F | F | H |
| A-637 | (CH₂)₂C₆H₄CN | H | F | F | F | H |
| A-638 | (CH₂)₂C₆H₄CH₃ | H | F | F | F | H |
| A-639 | (CH₂)₂C₆H₄CF₃ | H | F | F | F | H |
| A-640 | (CH₂)₂C₆H₄OCH₃ | H | F | F | F | H |
| A-641 | (CH₂)₂C₆H₄OCF₃ | H | F | F | F | H |
| A-642 | CH₂CH═CH₂ | H | F | F | F | H |
| A-643 | cyclo-C₃H₅ | H | F | F | F | H |
| A-644 | (CH₂)₂NHCH₃ | H | F | F | F | H |
| A-645 | H | H | Cl | Cl | CF₃ | H |
| A-646 | CH₃ | CH₃ | Cl | Cl | CF₃ | H |
| A-647 | CH₂CH₃ | CH₂CH₃ | Cl | Cl | CF₃ | H |
| A-648 | CH₃ | H | Cl | Cl | CF₃ | H |
| A-649 | CH₂CH₃ | H | Cl | Cl | CF₃ | H |
| A-650 | (CH₂)₂CH₃ | H | Cl | Cl | CF₃ | H |
| A-651 | CH(CH₃)₂ | H | Cl | Cl | CF₃ | H |
| A-652 | CH₂CF₃ | H | Cl | Cl | CF₃ | H |
| A-653 | C(CH₃)₃ | H | Cl | Cl | CF₃ | H |
| A-654 | CH₂CH(CH₃)₂ | H | Cl | Cl | CF₃ | H |
| A-655 | CH(CH₃)CH₂CH₃ | H | Cl | Cl | CF₃ | H |
| A-656 | (CH₂)₂OCH₃ | H | Cl | Cl | CF₃ | H |
| A-657 | CH₂CH(OCH₃)₂ | H | Cl | Cl | CF₃ | H |
| A-658 | CH₂CH(OCH₂CH₃)₂ | H | Cl | Cl | CF₃ | H |
| A-659 | CH₂C₆H₅ | H | Cl | Cl | CF₃ | H |
| A-660 | CH(CH₃)C₆H₅ | H | Cl | Cl | CF₃ | H |
| A-661 | (CH₂)₂OC₆H₅ | H | Cl | Cl | CF₃ | H |
| A-662 | (CH₂)₂C₆H₅ | H | Cl | Cl | CF₃ | H |
| A-663 | (CH₂)₂C₆H₄F | H | Cl | Cl | CF₃ | H |
| A-664 | (CH₂)₂C₆H₄Cl | H | Cl | Cl | CF₃ | H |
| A-665 | (CH₂)₂C₆H₄CN | H | Cl | Cl | CF₃ | H |
| A-666 | (CH₂)₂C₆H₄CH₃ | H | Cl | Cl | CF₃ | H |
| A-667 | (CH₂)₂C₆H₄CF₃ | H | Cl | Cl | CF₃ | H |
| A-668 | (CH₂)₂C₆H₄OCH₃ | H | Cl | Cl | CF₃ | H |
| A-669 | (CH₂)₂C₆H₄OCF₃ | H | Cl | Cl | CF₃ | H |
| A-670 | CH₂CH═CH₂ | H | Cl | Cl | CF₃ | H |
| A-671 | cyclo-C₃H₅ | H | Cl | Cl | CF₃ | H |
| A-672 | (CH₂)₂NHCH₃ | H | Cl | Cl | CF₃ | H |
| A-673 | H | H | CF₃ | Cl | Cl | H |
| A-674 | CH₃ | CH₃ | CF₃ | Cl | Cl | H |
| A-675 | CH₂CH₃ | CH₂CH₃ | CF₃ | Cl | Cl | H |
| A-676 | CH₃ | H | CF₃ | Cl | Cl | H |
| A-677 | CH₂CH₃ | H | CF₃ | Cl | Cl | H |
| A-678 | (CH₂)₂CH₃ | H | CF₃ | Cl | Cl | H |
| A-679 | CH(CH₃)₂ | H | CF₃ | Cl | Cl | H |
| A-680 | CH₂CF₃ | H | CF₃ | Cl | Cl | H |
| A-681 | C(CH₃)₃ | H | CF₃ | Cl | Cl | H |
| A-682 | CH₂CH(CH₃)₂ | H | CF₃ | Cl | Cl | H |
| A-683 | CH(CH₃)CH₂CH₃ | H | CF₃ | Cl | Cl | H |
| A-684 | (CH₂)₂OCH₃ | H | CF₃ | Cl | Cl | H |
| A-685 | CH₂CH(OCH₃)₂ | H | CF₃ | Cl | Cl | H |
| A-686 | CH₂CH(OCH₂CH₃)₂ | H | CF₃ | Cl | Cl | H |
| A-687 | CH₂C₆H₅ | H | CF₃ | Cl | Cl | H |
| A-688 | CH(CH₃)C₆H₅ | H | CF₃ | Cl | Cl | H |
| A-689 | (CH₂)₂OC₆H₅ | H | CF₃ | Cl | Cl | H |
| A-690 | (CH₂)₂C₆H₅ | H | CF₃ | Cl | Cl | H |
| A-691 | (CH₂)₂C₆H₄F | H | CF₃ | Cl | Cl | H |
| A-692 | (CH₂)₂C₆H₄Cl | H | CF₃ | Cl | Cl | H |
| A-693 | (CH₂)₂C₆H₄CN | H | CF₃ | Cl | Cl | H |
| A-694 | (CH₂)₂C₆H₄CH₃ | H | CF₃ | Cl | Cl | H |
| A-695 | (CH₂)₂C₆H₄CF₃ | H | CF₃ | Cl | Cl | H |
| A-696 | (CH₂)₂C₆H₄OCH₃ | H | CF₃ | Cl | Cl | H |
| A-697 | (CH₂)₂C₆H₄OCF₃ | H | CF₃ | Cl | Cl | H |
| A-698 | CH₂CH═CH₂ | H | CF₃ | Cl | Cl | H |
| A-699 | cyclo-C₃H₅ | H | CF₃ | Cl | Cl | H |
| A-700 | (CH₂)₂NHCH₃ | H | CF₃ | Cl | Cl | H |
| A-701 | H | H | CF₃ | Cl | F | H |
| A-702 | CH₃ | CH₃ | CF₃ | Cl | F | H |
| A-703 | CH₂CH₃ | CH₂CH₃ | CF₃ | Cl | F | H |
| A-704 | CH₃ | H | CF₃ | Cl | F | H |
| A-705 | CH₂CH₃ | H | CF₃ | Cl | F | H |
| A-706 | (CH₂)₂CH₃ | H | CF₃ | Cl | F | H |
| A-707 | CH(CH₃)₂ | H | CF₃ | Cl | F | H |
| A-708 | CH₂CF₃ | H | CF₃ | Cl | F | H |
| A-709 | C(CH₃)₃ | H | CF₃ | Cl | F | H |
| A-710 | CH₂CH(CH₃)₂ | H | CF₃ | Cl | F | H |
| A-711 | CH(CH₃)CH₂CH₃ | H | CF₃ | Cl | F | H |
| A-712 | (CH₂)₂OCH₃ | H | CF₃ | Cl | F | H |
| A-713 | CH₂CH(OCH₃)₂ | H | CF₃ | Cl | F | H |
| A-714 | CH₂CH(OCH₂CH₃)₂ | H | CF₃ | Cl | F | H |
| A-715 | CH₂C₆H₅ | H | CF₃ | Cl | F | H |
| A-716 | CH(CH₃)C₆H₅ | H | CF₃ | Cl | F | H |
| A-717 | (CH₂)₂OC₆H₅ | H | CF₃ | Cl | F | H |
| A-718 | (CH₂)₂C₆H₅ | H | CF₃ | Cl | F | H |
| A-719 | (CH₂)₂C₆H₄F | H | CF₃ | Cl | F | H |
| A-720 | (CH₂)₂C₆H₄Cl | H | CF₃ | Cl | F | H |
| A-721 | (CH₂)₂C₆H₄CN | H | CF₃ | Cl | F | H |
| A-722 | (CH₂)₂C₆H₄CH₃ | H | CF₃ | Cl | F | H |
| A-723 | (CH₂)₂C₆H₄CF₃ | H | CF₃ | Cl | F | H |
| A-724 | (CH₂)₂C₆H₄OCH₃ | H | CF₃ | Cl | F | H |
| A-725 | (CH₂)₂C₆H₄OCF₃ | H | CF₃ | Cl | F | H |
| A-726 | CH₂CH═CH₂ | H | CF₃ | Cl | F | H |
| A-727 | cyclo-C₃H₅ | H | CF₃ | Cl | F | H |
| A-728 | (CH₂)₂NHCH₃ | H | CF₃ | Cl | F | H |
| A-729 | H | H | F | Cl | CF₃ | H |
| A-730 | CH₃ | CH₃ | F | Cl | CF₃ | H |
| A-731 | CH₂CH₃ | CH₂CH₃ | F | Cl | CF₃ | H |
| A-732 | CH₃ | H | F | Cl | CF₃ | H |
| A-733 | CH₂CH₃ | H | F | Cl | CF₃ | H |
| A-734 | (CH₂)₂CH₃ | H | F | Cl | CF₃ | H |
| A-735 | CH(CH₃)₂ | H | F | Cl | CF₃ | H |
| A-736 | CH₂CF₃ | H | F | Cl | CF₃ | H |
| A-737 | C(CH₃)₃ | H | F | Cl | CF₃ | H |
| A-738 | CH₂CH(CH₃)₂ | H | F | Cl | CF₃ | H |
| A-739 | CH(CH₃)CH₂CH₃ | H | F | Cl | CF₃ | H |
| A-740 | (CH₂)₂OCH₃ | H | F | Cl | CF₃ | H |
| A-741 | CH₂CH(OCH₃)₂ | H | F | Cl | CF₃ | H |
| A-742 | CH₂CH(OCH₂CH₃)₂ | H | F | Cl | CF₃ | H |
| A-743 | CH₂C₆H₅ | H | F | Cl | CF₃ | H |
| A-744 | CH(CH₃)C₆H₅ | H | F | Cl | CF₃ | H |
| A-745 | (CH₂)₂OC₆H₅ | H | F | Cl | CF₃ | H |
| A-746 | (CH₂)₂C₆H₅ | H | F | Cl | CF₃ | H |
| A-747 | (CH₂)₂C₆H₄F | H | F | Cl | CF₃ | H |
| A-748 | (CH₂)₂C₆H₄Cl | H | F | Cl | CF₃ | H |
| A-749 | (CH₂)₂C₆H₄CN | H | F | Cl | CF₃ | H |
| A-750 | (CH₂)₂C₆H₄CH₃ | H | F | Cl | CF₃ | H |
| A-751 | (CH₂)₂C₆H₄CF₃ | H | F | Cl | CF₃ | H |
| A-752 | (CH₂)₂C₆H₄OCH₃ | H | F | Cl | CF₃ | H |
| A-753 | (CH₂)₂C₆H₄OCF₃ | H | F | Cl | CF₃ | H |
| A-754 | CH₂CH═CH₂ | H | F | Cl | CF₃ | H |
| A-755 | cyclo-C₃H₅ | H | F | Cl | CF₃ | H |
| A-756 | (CH₂)₂NHCH₃ | H | F | Cl | CF₃ | H |
| A-757 | H | H | F | Cl | CF₃ | H |
| A-758 | CH₃ | CH₃ | F | Cl | CF₃ | H |
| A-759 | CH₂CH₃ | CH₂CH₃ | F | Cl | CF₃ | H |
| A-760 | CH₃ | H | F | Cl | CF₃ | H |
| A-761 | CH₂CH₃ | H | F | Cl | CF₃ | H |
| A-762 | (CH₂)₂CH₃ | H | F | Cl | CF₃ | H |
| A-763 | CH(CH₃)₂ | H | F | Cl | CF₃ | H |
| A-764 | CH₂CF₃ | H | F | Cl | CF₃ | H |
| A-765 | C(CH₃)₃ | H | F | Cl | CF₃ | H |
| A-766 | CH₂CH(CH₃)₂ | H | F | Cl | CF₃ | H |
| A-767 | CH(CH₃)CH₂CH₃ | H | F | Cl | CF₃ | H |
| A-768 | (CH₂)₂OCH₃ | H | F | Cl | CF₃ | H |
| A-769 | CH₂CH(OCH₃)₂ | H | F | Cl | CF₃ | H |
| A-770 | CH₂CH(OCH₂CH₃)₂ | H | F | Cl | CF₃ | H |
| A-771 | CH₂C₆H₅ | H | F | Cl | CF₃ | H |
| A-772 | CH(CH₃)C₆H₅ | H | F | Cl | CF₃ | H |
| A-773 | (CH₂)₂OC₆H₅ | H | F | Cl | CF₃ | H |
| A-774 | (CH₂)₂C₆H₅ | H | F | Cl | CF₃ | H |
| A-775 | (CH₂)₂C₆H₄F | H | F | Cl | CF₃ | H |
| A-776 | (CH₂)₂C₆H₄Cl | H | F | Cl | CF₃ | H |
| A-777 | (CH₂)₂C₆H₄CN | H | F | Cl | CF₃ | H |
| A-778 | (CH₂)₂C₆H₄CH₃ | H | F | Cl | CF₃ | H |
| A-779 | (CH₂)₂C₆H₄CF₃ | H | F | Cl | CF₃ | H |
| A-780 | (CH₂)₂C₆H₄OCH₃ | H | F | Cl | CF₃ | H |
| A-781 | (CH₂)₂C₆H₄OCF₃ | H | F | Cl | CF₃ | H |
| A-782 | CH₂CH═CH₂ | H | F | Cl | CF₃ | H |
| A-783 | cyclo-C₃H₅ | H | F | Cl | CF₃ | H |
| A-784 | (CH₂)₂NHCH₃ | H | F | Cl | CF₃ | H |
| A-785 | H | H | Cl | H | CF₃ | 6-Cl |
| A-786 | CH₃ | CH₃ | Cl | H | CF₃ | 6-Cl |
| A-787 | CH₂CH₃ | CH₂CH₃ | Cl | H | CF₃ | 6-Cl |
| A-788 | CH₃ | H | Cl | H | CF₃ | 6-Cl |
| A-789 | CH₂CH₃ | H | Cl | H | CF₃ | 6-Cl |
| A-790 | (CH₂)₂CH₃ | H | Cl | H | CF₃ | 6-Cl |
| A-791 | CH(CH₃)₂ | H | Cl | H | CF₃ | 6-Cl |
| A-792 | CH₂CF₃ | H | Cl | H | CF₃ | 6-Cl |
| A-793 | C(CH₃)₃ | H | Cl | H | CF₃ | 6-Cl |
| A-794 | CH₂CH(CH₃)₂ | H | Cl | H | CF₃ | 6-Cl |
| A-795 | CH(CH₃)CH₂CH₃ | H | Cl | H | CF₃ | 6-Cl |
| A-796 | (CH₂)₂OCH₃ | H | Cl | H | CF₃ | 6-Cl |
| A-797 | CH₂CH(OCH₃)₂ | H | Cl | H | CF₃ | 6-Cl |
| A-798 | CH₂CH(OCH₂CH₃)₂ | H | Cl | H | CF₃ | 6-Cl |
| A-799 | CH₂C₆H₅ | H | Cl | H | CF₃ | 6-Cl |
| A-800 | CH(CH₃)C₆H₅ | H | Cl | H | CF₃ | 6-Cl |
| A-801 | (CH₂)₂OC₆H₅ | H | Cl | H | CF₃ | 6-Cl |
| A-802 | (CH₂)₂C₆H₅ | H | Cl | H | CF₃ | 6-Cl |
| A-803 | (CH₂)₂C₆H₄F | H | Cl | H | CF₃ | 6-Cl |
| A-804 | (CH₂)₂C₆H₄Cl | H | Cl | H | CF₃ | 6-Cl |
| A-805 | (CH₂)₂C₆H₄CN | H | Cl | H | CF₃ | 6-Cl |
| A-806 | (CH₂)₂C₆H₄CH₃ | H | Cl | H | CF₃ | 6-Cl |
| A-807 | (CH₂)₂C₆H₄CF₃ | H | Cl | H | CF₃ | 6-Cl |
| A-808 | (CH₂)₂C₆H₄OCH₃ | H | Cl | H | CF₃ | 6-Cl |
| A-809 | (CH₂)₂C₆H₄OCF₃ | H | Cl | H | CF₃ | 6-Cl |
| A-810 | CH₂CH═CH₂ | H | Cl | H | CF₃ | 6-Cl |
| A-811 | cyclo-C₃H₅ | H | Cl | H | CF₃ | 6-Cl |
| A-812 | (CH₂)₂NHCH₃ | H | Cl | H | CF₃ | 6-Cl |
| A-813 | H | H | Cl | H | F | 6-Cl |
| A-814 | CH₃ | CH₃ | Cl | H | F | 6-Cl |
| A-815 | CH₂CH₃ | CH₂CH₃ | Cl | H | F | 6-Cl |
| A-816 | CH₃ | H | Cl | H | F | 6-Cl |
| A-817 | CH₂CH₃ | H | Cl | H | F | 6-Cl |
| A-818 | (CH₂)₂CH₃ | H | Cl | H | F | 6-Cl |
| A-819 | CH(CH₃)₂ | H | Cl | H | F | 6-Cl |
| A-820 | CH₂CF₃ | H | Cl | H | F | 6-Cl |
| A-821 | C(CH₃)₃ | H | Cl | H | F | 6-Cl |
| A-822 | CH₂CH(CH₃)₂ | H | Cl | H | F | 6-Cl |
| A-823 | CH(CH₃)CH₂CH₃ | H | Cl | H | F | 6-Cl |
| A-824 | (CH₂)₂OCH₃ | H | Cl | H | F | 6-Cl |
| A-825 | CH₂CH(OCH₃)₂ | H | Cl | H | F | 6-Cl |
| A-826 | CH₂CH(OCH₂CH₃)₂ | H | Cl | H | F | 6-Cl |
| A-827 | CH₂C₆H₅ | H | Cl | H | F | 6-Cl |
| A-828 | CH(CH₃)C₆H₅ | H | Cl | H | F | 6-Cl |
| A-829 | (CH₂)₂OC₆H₅ | H | Cl | H | F | 6-Cl |
| A-830 | (CH₂)₂C₆H₅ | H | Cl | H | F | 6-Cl |
| A-831 | (CH₂)₂C₆H₄F | H | Cl | H | F | 6-Cl |
| A-832 | (CH₂)₂C₆H₄Cl | H | Cl | H | F | 6-Cl |
| A-833 | (CH₂)₂C₆H₄CN | H | Cl | H | F | 6-Cl |
| A-834 | (CH₂)₂C₆H₄CH₃ | H | Cl | H | F | 6-Cl |
| A-835 | (CH₂)₂C₆H₄CF₃ | H | Cl | H | F | 6-Cl |
| A-836 | (CH₂)₂C₆H₄OCH₃ | H | Cl | H | F | 6-Cl |
| A-837 | (CH₂)₂C₆H₄OCF₃ | H | Cl | H | F | 6-Cl |
| A-838 | CH₂CH═CH₂ | H | Cl | H | F | 6-Cl |
| A-839 | cyclo-C₃H₅ | H | Cl | H | F | 6-Cl |
| A-840 | (CH₂)₂NHCH₃ | H | Cl | H | F | 6-Cl |
| A-841 | H | H | F | H | Cl | 6-Cl |
| A-842 | CH₃ | CH₃ | F | H | Cl | 6-Cl |
| A-843 | CH₂CH₃ | CH₂CH₃ | F | H | Cl | 6-Cl |
| A-844 | CH₃ | H | F | H | Cl | 6-Cl |
| A-845 | CH₂CH₃ | H | F | H | Cl | 6-Cl |
| A-846 | (CH₂)₂CH₃ | H | F | H | Cl | 6-Cl |
| A-847 | CH(CH₃)₂ | H | F | H | Cl | 6-Cl |
| A-848 | CH₂CF₃ | H | F | H | Cl | 6-Cl |
| A-849 | C(CH₃)₃ | H | F | H | Cl | 6-Cl |
| A-850 | CH₂CH(CH₃)₂ | H | F | H | Cl | 6-Cl |
| A-851 | CH(CH₃)CH₂CH₃ | H | F | H | Cl | 6-Cl |
| A-852 | (CH₂)₂OCH₃ | H | F | H | Cl | 6-Cl |
| A-853 | CH₂CH(OCH₃)₂ | H | F | H | Cl | 6-Cl |
| A-854 | CH₂CH(OCH₂CH₃)₂ | H | F | H | Cl | 6-Cl |
| A-855 | CH₂C₆H₅ | H | F | H | Cl | 6-Cl |
| A-856 | CH(CH₃)C₆H₅ | H | F | H | Cl | 6-Cl |
| A-857 | (CH₂)₂OC₆H₅ | H | F | H | Cl | 6-Cl |
| A-858 | (CH₂)₂C₆H₅ | H | F | H | Cl | 6-Cl |
| A-859 | (CH₂)₂C₆H₄F | H | F | H | Cl | 6-Cl |
| A-860 | (CH₂)₂C₆H₄Cl | H | F | H | Cl | 6-Cl |
| A-861 | (CH₂)₂C₆H₄CN | H | F | H | Cl | 6-Cl |
| A-862 | (CH₂)₂C₆H₄CH₃ | H | F | H | Cl | 6-Cl |
| A-863 | (CH₂)₂C₆H₄CF₃ | H | F | H | Cl | 6-Cl |
| A-864 | (CH₂)₂C₆H₄OCH₃ | H | F | H | Cl | 6-Cl |
| A-865 | (CH₂)₂C₆H₄OCF₃ | H | F | H | Cl | 6-Cl |
| A-866 | CH₂CH═CH₂ | H | F | H | Cl | 6-Cl |
| A-867 | cyclo-C₃H₅ | H | F | H | Cl | 6-Cl |
| A-868 | (CH₂)₂NHCH₃ | H | F | H | Cl | 6-Cl |
| A-869 | H | H | Cl | H | Cl | 6-Cl |
| A-870 | CH₃ | CH₃ | Cl | H | Cl | 6-Cl |
| A-871 | CH₂CH₃ | CH₂CH₃ | Cl | H | Cl | 6-Cl |
| A-872 | CH₃ | H | Cl | H | Cl | 6-Cl |
| A-873 | CH₂CH₃ | H | Cl | H | Cl | 6-Cl |
| A-874 | (CH₂)₂CH₃ | H | Cl | H | Cl | 6-Cl |
| A-875 | CH(CH₃)₂ | H | Cl | H | Cl | 6-Cl |
| A-876 | CH₂CF₃ | H | Cl | H | Cl | 6-Cl |
| A-877 | C(CH₃)₃ | H | Cl | H | Cl | 6-Cl |
| A-878 | CH₂CH(CH₃)₂ | H | Cl | H | Cl | 6-Cl |
| A-879 | CH(CH₃)CH₂CH₃ | H | Cl | H | Cl | 6-Cl |
| A-880 | (CH₂)₂OCH₃ | H | Cl | H | Cl | 6-Cl |
| A-881 | CH₂CH(OCH₃)₂ | H | Cl | H | Cl | 6-Cl |
| A-882 | CH₂CH(OCH₂CH₃)₂ | H | Cl | H | Cl | 6-Cl |
| A-883 | CH₂C₆H₅ | H | Cl | H | Cl | 6-Cl |
| A-884 | CH(CH₃)C₆H₅ | H | Cl | H | Cl | 6-Cl |
| A-885 | (CH₂)₂OC₆H₅ | H | Cl | H | Cl | 6-Cl |
| A-886 | (CH₂)₂C₆H₅ | H | Cl | H | Cl | 6-Cl |
| A-887 | (CH₂)₂C₆H₄F | H | Cl | H | Cl | 6-Cl |
| A-888 | (CH₂)₂C₆H₄Cl | H | Cl | H | Cl | 6-Cl |
| A-889 | (CH₂)₂C₆H₄CN | H | Cl | H | Cl | 6-Cl |
| A-890 | (CH₂)₂C₆H₄CH₃ | H | Cl | H | Cl | 6-Cl |
| A-891 | (CH₂)₂C₆H₄CF₃ | H | Cl | H | Cl | 6-Cl |
| A-892 | (CH₂)₂C₆H₄OCH₃ | H | Cl | H | Cl | 6-Cl |
| A-893 | (CH₂)₂C₆H₄OCF₃ | H | Cl | H | Cl | 6-Cl |
| A-894 | CH₂CH═CH₂ | H | Cl | H | Cl | 6-Cl |
| A-895 | cyclo-C₃H₅ | H | Cl | H | Cl | 6-Cl |
| A-896 | (CH₂)₂NHCH₃ | H | Cl | H | Cl | 6-Cl |
| A-897 | H | H | F | H | Cl | 6-F |
| A-898 | CH₃ | CH₃ | F | H | Cl | 6-F |
| A-899 | CH₂CH₃ | CH₂CH₃ | F | H | Cl | 6-F |
| A-900 | CH₃ | H | F | H | Cl | 6-F |
| A-901 | CH₂CH₃ | H | F | H | Cl | 6-F |
| A-902 | (CH₂)₂CH₃ | H | F | H | Cl | 6-F |
| A-903 | CH(CH₃)₂ | H | F | H | Cl | 6-F |
| A-904 | CH₂CF₃ | H | F | H | Cl | 6-F |
| A-905 | C(CH₃)₃ | H | F | H | Cl | 6-F |
| A-906 | CH₂CH(CH₃)₂ | H | F | H | Cl | 6-F |
| A-907 | CH(CH₃)CH₂CH₃ | H | F | H | Cl | 6-F |
| A-908 | (CH₂)₂OCH₃ | H | F | H | Cl | 6-F |
| A-909 | CH₂CH(OCH₃)₂ | H | F | H | Cl | 6-F |
| A-910 | CH₂CH(OCH₂CH₃)₂ | H | F | H | Cl | 6-F |
| A-911 | CH₂C₆H₅ | H | F | H | Cl | 6-F |
| A-912 | CH(CH₃)C₆H₅ | H | F | H | Cl | 6-F |
| A-913 | (CH₂)₂OC₆H₅ | H | F | H | Cl | 6-F |
| A-914 | (CH₂)₂C₆H₅ | H | F | H | Cl | 6-F |
| A-915 | (CH₂)₂C₆H₄F | H | F | H | Cl | 6-F |
| A-916 | (CH₂)₂C₆H₄Cl | H | F | H | Cl | 6-F |
| A-917 | (CH₂)₂C₆H₄CN | H | F | H | Cl | 6-F |
| A-918 | (CH₂)₂C₆H₄CH₃ | H | F | H | Cl | 6-F |
| A-919 | (CH₂)₂C₆H₄CF₃ | H | F | H | Cl | 6-F |
| A-920 | (CH₂)₂C₆H₄OCH₃ | H | F | H | Cl | 6-F |
| A-921 | (CH₂)₂C₆H₄OCF₃ | H | F | H | Cl | 6-F |
| A-922 | CH₂CH═CH₂ | H | F | H | Cl | 6-F |
| A-923 | cyclo-C₃H₅ | H | F | H | Cl | 6-F |
| A-924 | (CH₂)₂NHCH₃ | H | F | H | Cl | 6-F |
| A-925 | H | H | F | H | F | 6-Cl |
| A-926 | CH₃ | CH₃ | F | H | F | 6-Cl |
| A-927 | CH₂CH₃ | CH₂CH₃ | F | H | F | 6-Cl |
| A-928 | CH₃ | H | F | H | F | 6-Cl |
| A-929 | CH₂CH₃ | H | F | H | F | 6-Cl |
| A-930 | (CH₂)₂CH₃ | H | F | H | F | 6-Cl |
| A-931 | CH(CH₃)₂ | H | F | H | F | 6-Cl |
| A-932 | CH₂CF₃ | H | F | H | F | 6-Cl |
| A-933 | C(CH₃)₃ | H | F | H | F | 6-Cl |
| A-934 | CH₂CH(CH₃)₂ | H | F | H | F | 6-Cl |
| A-935 | CH(CH₃)CH₂CH₃ | H | F | H | F | 6-Cl |
| A-936 | (CH₂)₂OCH₃ | H | F | H | F | 6-Cl |
| A-937 | CH₂CH(OCH₃)₂ | H | F | H | F | 6-Cl |
| A-938 | CH₂CH(OCH₂CH₃)₂ | H | F | H | F | 6-Cl |
| A-939 | CH₂C₆H₅ | H | F | H | F | 6-Cl |
| A-940 | CH(CH₃)C₆H₅ | H | F | H | F | 6-Cl |
| A-941 | (CH₂)₂OC₆H₅ | H | F | H | F | 6-Cl |
| A-942 | (CH₂)₂C₆H₅ | H | F | H | F | 6-Cl |
| A-943 | (CH₂)₂C₆H₄F | H | F | H | F | 6-Cl |
| A-944 | (CH₂)₂C₆H₄Cl | H | F | H | F | 6-Cl |
| A-945 | (CH₂)₂C₆H₄CN | H | F | H | F | 6-Cl |
| A-946 | (CH₂)₂C₆H₄CH₃ | H | F | H | F | 6-Cl |
| A-947 | (CH₂)₂C₆H₄CF₃ | H | F | H | F | 6-Cl |
| A-948 | (CH₂)₂C₆H₄OCH₃ | H | F | H | F | 6-Cl |
| A-949 | (CH₂)₂C₆H₄OCF₃ | H | F | H | F | 6-Cl |
| A-950 | CH₂CH═CH₂ | H | F | H | F | 6-Cl |
| A-951 | cyclo-C₃H₅ | H | F | H | F | 6-Cl |
| A-952 | (CH₂)₂NHCH₃ | H | F | H | F | 6-Cl |
| A-953 | H | H | F | H | CF₃ | 6-F |
| A-954 | CH₃ | CH₃ | F | H | CF₃ | 6-F |
| A-955 | CH₂CH₃ | CH₂CH₃ | F | H | CF₃ | 6-F |
| A-956 | CH₃ | H | F | H | CF₃ | 6-F |
| A-957 | CH₂CH₃ | H | F | H | CF₃ | 6-F |
| A-958 | (CH₂)₂CH₃ | H | F | H | CF₃ | 6-F |
| A-959 | CH(CH₃)₂ | H | F | H | CF₃ | 6-F |
| A-960 | CH₂CF₃ | H | F | H | CF₃ | 6-F |
| A-961 | C(CH₃)₃ | H | F | H | CF₃ | 6-F |
| A-962 | CH₂CH(CH₃)₂ | H | F | H | CF₃ | 6-F |
| A-963 | CH(CH₃)CH₂CH₃ | H | F | H | CF₃ | 6-F |
| A-964 | (CH₂)₂OCH₃ | H | F | H | CF₃ | 6-F |
| A-965 | CH₂CH(OCH₃)₂ | H | F | H | CF₃ | 6-F |
| A-966 | CH₂CH(OCH₂CH₃)₂ | H | F | H | CF₃ | 6-F |
| A-967 | CH₂C₆H₅ | H | F | H | CF₃ | 6-F |
| A-968 | CH(CH₃)C₆H₅ | H | F | H | CF₃ | 6-F |
| A-969 | (CH₂)₂OC₆H₅ | H | F | H | CF₃ | 6-F |
| A-970 | (CH₂)₂C₆H₅ | H | F | H | CF₃ | 6-F |
| A-971 | (CH₂)₂C₆H₄F | H | F | H | CF₃ | 6-F |
| A-972 | (CH₂)₂C₆H₄Cl | H | F | H | CF₃ | 6-F |
| A-973 | (CH₂)₂C₆H₄CN | H | F | H | CF₃ | 6-F |
| A-974 | (CH₂)₂C₆H₄CH₃ | H | F | H | CF₃ | 6-F |
| A-975 | (CH₂)₂C₆H₄CF₃ | H | F | H | CF₃ | 6-F |
| A-976 | (CH₂)₂C₆H₄OCH₃ | H | F | H | CF₃ | 6-F |
| A-977 | (CH₂)₂C₆H₄OCF₃ | H | F | H | CF₃ | 6-F |
| A-978 | CH₂CH═CH₂ | H | F | H | CF₃ | 6-F |
| A-979 | cyclo-C₃H₅ | H | F | H | CF₃ | 6-F |
| A-980 | (CH₂)₂NHCH₃ | H | F | H | CF₃ | 6-F |
| A-981 | H | H | CF₃ | H | F | 6-F |
| A-982 | CH₃ | CH₃ | CF₃ | H | F | 6-F |
| A-983 | CH₂CH₃ | CH₂CH₃ | CF₃ | H | F | 6-F |
| A-984 | CH₃ | H | CF₃ | H | F | 6-F |
| A-985 | CH₂CH₃ | H | CF₃ | H | F | 6-F |
| A-986 | (CH₂)₂CH₃ | H | CF₃ | H | F | 6-F |
| A-987 | CH(CH₃)₂ | H | CF₃ | H | F | 6-F |
| A-988 | CH₂CF₃ | H | CF₃ | H | F | 6-F |
| A-989 | C(CH₃)₃ | H | CF₃ | H | F | 6-F |
| A-990 | CH₂CH(CH₃)₂ | H | CF₃ | H | F | 6-F |
| A-991 | CH(CH₃)CH₂CH₃ | H | CF₃ | H | F | 6-F |
| A-992 | (CH₂)₂OCH₃ | H | CF₃ | H | F | 6-F |
| A-993 | CH₂CH(OCH₃)₂ | H | CF₃ | H | F | 6-F |
| A-994 | CH₂CH(OCH₂CH₃)₂ | H | CF₃ | H | F | 6-F |
| A-995 | CH₂C₆H₅ | H | CF₃ | H | F | 6-F |
| A-996 | CH(CH₃)C₆H₅ | H | CF₃ | H | F | 6-F |
| A-997 | (CH₂)₂OC₆H₅ | H | CF₃ | H | F | 6-F |
| A-998 | (CH₂)₂C₆H₅ | H | CF₃ | H | F | 6-F |
| A-999 | (CH₂)₂C₆H₄F | H | CF₃ | H | F | 6-F |
| A-1000 | (CH₂)₂C₆H₄Cl | H | CF₃ | H | F | 6-F |
| A-1001 | (CH₂)₂C₆H₄CN | H | CF₃ | H | F | 6-F |
| A-1002 | (CH₂)₂C₆H₄CH₃ | H | CF₃ | H | F | 6-F |
| A-1003 | (CH₂)₂C₆H₄CF₃ | H | CF₃ | H | F | 6-F |
| A-1004 | (CH₂)₂C₆H₄OCH₃ | H | CF₃ | H | F | 6-F |
| A-1005 | (CH₂)₂C₆H₄OCF₃ | H | CF₃ | H | F | 6-F |
| A-1006 | CH₂CH═CH₂ | H | CF₃ | H | F | 6-F |
| A-1007 | cyclo-C₃H₅ | H | CF₃ | H | F | 6-F |
| A-1008 | (CH₂)₂NHCH₃ | H | CF₃ | H | F | 6-F |
| A-1009 | H | H | CF₃ | H | F | 6-CF₃ |
| A-1010 | CH₃ | CH₃ | CF₃ | H | F | 6-CF₃ |
| A-1011 | CH₂CH₃ | CH₂CH₃ | CF₃ | H | F | 6-CF₃ |
| A-1012 | CH₃ | H | CF₃ | H | F | 6-CF₃ |
| A-1013 | CH₂CH₃ | H | CF₃ | H | F | 6-CF₃ |
| A-1014 | (CH₂)₂CH₃ | H | CF₃ | H | F | 6-CF₃ |
| A-1015 | CH(CH₃)₂ | H | CF₃ | H | F | 6-CF₃ |
| A-1016 | CH₂CF₃ | H | CF₃ | H | F | 6-CF₃ |
| A-1017 | C(CH₃)₃ | H | CF₃ | H | F | 6-CF₃ |
| A-1018 | CH₂CH(CH₃)₂ | H | CF₃ | H | F | 6-CF₃ |
| A-1019 | CH(CH₃)CH₂CH₃ | H | CF₃ | H | F | 6-CF₃ |
| A-1020 | (CH₂)₂OCH₃ | H | CF₃ | H | F | 6-CF₃ |
| A-1021 | CH₂CH(OCH₃)₂ | H | CF₃ | H | F | 6-CF₃ |
| A-1022 | CH₂CH(OCH₂CH₃)₂ | H | CF₃ | H | F | 6-CF₃ |
| A-1023 | CH₂C₆H₅ | H | CF₃ | H | F | 6-CF₃ |
| A-1024 | CH(CH₃)C₆H₅ | H | CF₃ | H | F | 6-CF₃ |
| A-1025 | (CH₂)₂OC₆H₅ | H | CF₃ | H | F | 6-CF₃ |
| A-1026 | (CH₂)₂C₆H₅ | H | CF₃ | H | F | 6-CF₃ |
| A-1027 | (CH₂)₂C₆H₄F | H | CF₃ | H | F | 6-CF₃ |
| A-1028 | (CH₂)₂C₆H₄Cl | H | CF₃ | H | F | 6-CF₃ |
| A-1029 | (CH₂)₂C₆H₄CN | H | CF₃ | H | F | 6-CF₃ |
| A-1030 | (CH₂)₂C₆H₄CH₃ | H | CF₃ | H | F | 6-CF₃ |
| A-1031 | (CH₂)₂C₆H₄CF₃ | H | CF₃ | H | F | 6-CF₃ |
| A-1032 | (CH₂)₂C₆H₄OCH₃ | H | CF₃ | H | F | 6-CF₃ |
| A-1033 | (CH₂)₂C₆H₄OCF₃ | H | CF₃ | H | F | 6-CF₃ |
| A-1034 | CH₂CH═CH₂ | H | CF₃ | H | F | 6-CF₃ |
| A-1035 | cyclo-C₃H₅ | H | CF₃ | H | F | 6-CF₃ |
| A-1036 | (CH₂)₂NHCH₃ | H | CF₃ | H | F | 6-CF₃ |
| A-1037 | H | H | CF₃ | H | CF₃ | 6-F |
| A-1038 | CH₃ | CH₃ | CF₃ | H | CF₃ | 6-F |
| A-1039 | CH₂CH₃ | CH₂CH₃ | CF₃ | H | CF₃ | 6-F |
| A-1040 | CH₃ | H | CF₃ | H | CF₃ | 6-F |
| A-1041 | CH₂CH₃ | H | CF₃ | H | CF₃ | 6-F |
| A-1042 | (CH₂)₂CH₃ | H | CF₃ | H | CF₃ | 6-F |
| A-1043 | CH(CH₃)₂ | H | CF₃ | H | CF₃ | 6-F |
| A-1044 | CH₂CF₃ | H | CF₃ | H | CF₃ | 6-F |
| A-1045 | C(CH₃)₃ | H | CF₃ | H | CF₃ | 6-F |
| A-1046 | CH₂CH(CH₃)₂ | H | CF₃ | H | CF₃ | 6-F |
| A-1047 | CH(CH₃)CH₂CH₃ | H | CF₃ | H | CF₃ | 6-F |
| A-1048 | (CH₂)₂OCH₃ | H | CF₃ | H | CF₃ | 6-F |
| A-1049 | CH₂CH(OCH₃)₂ | H | CF₃ | H | CF₃ | 6-F |
| A-1050 | CH₂CH(OCH₂CH₃)₂ | H | CF₃ | H | CF₃ | 6-F |
| A-1051 | CH₂C₆H₅ | H | CF₃ | H | CF₃ | 6-F |
| A-1052 | CH(CH₃)C₆H₅ | H | CF₃ | H | CF₃ | 6-F |
| A-1053 | (CH₂)₂OC₆H₅ | H | CF₃ | H | CF₃ | 6-F |
| A-1054 | (CH₂)₂C₆H₅ | H | CF₃ | H | CF₃ | 6-F |
| A-1055 | (CH₂)₂C₆H₄F | H | CF₃ | H | CF₃ | 6-F |
| A-1056 | (CH₂)₂C₆H₄Cl | H | CF₃ | H | CF₃ | 6-F |
| A-1057 | (CH₂)₂C₆H₄CN | H | CF₃ | H | CF₃ | 6-F |
| A-1058 | (CH₂)₂C₆H₄CH₃ | H | CF₃ | H | CF₃ | 6-F |
| A-1059 | (CH₂)₂C₆H₄CF₃ | H | CF₃ | H | CF₃ | 6-F |
| A-1060 | (CH₂)₂C₆H₄OCH₃ | H | CF₃ | H | CF₃ | 6-F |
| A-1061 | (CH₂)₂C₆H₄OCF₃ | H | CF₃ | H | CF₃ | 6-F |
| A-1062 | CH₂CH═CH₂ | H | CF₃ | H | CF₃ | 6-F |
| A-1063 | cyclo-C₃H₅ | H | CF₃ | H | CF₃ | 6-F |
| A-1064 | (CH₂)₂NHCH₃ | H | CF₃ | H | CF₃ | 6-F |
| A-1065 | H | H | CF₃ | H | CF₃ | 6-Cl |
| A-1066 | CH₃ | CH₃ | CF₃ | H | CF₃ | 6-Cl |
| A-1067 | CH₂CH₃ | CH₂CH₃ | CF₃ | H | CF₃ | 6-Cl |
| A-1068 | CH₃ | H | CF₃ | H | CF₃ | 6-Cl |
| A-1069 | CH₂CH₃ | H | CF₃ | H | CF₃ | 6-Cl |
| A-1070 | (CH₂)₂CH₃ | H | CF₃ | H | CF₃ | 6-Cl |
| A-1071 | CH(CH₃)₂ | H | CF₃ | H | CF₃ | 6-Cl |
| A-1072 | CH₂CF₃ | H | CF₃ | H | CF₃ | 6-Cl |
| A-1073 | C(CH₃)₃ | H | CF₃ | H | CF₃ | 6-Cl |
| A-1074 | CH₂CH(CH₃)₂ | H | CF₃ | H | CF₃ | 6-Cl |
| A-1075 | CH(CH₃)CH₂CH₃ | H | CF₃ | H | CF₃ | 6-Cl |
| A-1076 | (CH₂)₂OCH₃ | H | CF₃ | H | CF₃ | 6-Cl |
| A-1077 | CH₂CH(OCH₃)₂ | H | CF₃ | H | CF₃ | 6-Cl |
| A-1078 | CH₂CH(OCH₂CH₃)₂ | H | CF₃ | H | CF₃ | 6-Cl |
| A-1079 | CH₂C₆H₅ | H | CF₃ | H | CF₃ | 6-Cl |
| A-1080 | CH(CH₃)C₆H₅ | H | CF₃ | H | CF₃ | 6-Cl |
| A-1081 | (CH₂)₂OC₆H₅ | H | CF₃ | H | CF₃ | 6-Cl |
| A-1082 | (CH₂)₂C₆H₅ | H | CF₃ | H | CF₃ | 6-Cl |
| A-1083 | (CH₂)₂C₆H₄F | H | CF₃ | H | CF₃ | 6-Cl |
| A-1084 | (CH₂)₂C₆H₄Cl | H | CF₃ | H | CF₃ | 6-Cl |
| A-1085 | (CH₂)₂C₆H₄CN | H | CF₃ | H | CF₃ | 6-Cl |
| A-1086 | (CH₂)₂C₆H₄CH₃ | H | CF₃ | H | CF₃ | 6-Cl |
| A-1087 | (CH₂)₂C₆H₄CF₃ | H | CF₃ | H | CF₃ | 6-Cl |
| A-1088 | (CH₂)₂C₆H₄OCH₃ | H | CF₃ | H | CF₃ | 6-Cl |
| A-1089 | (CH₂)₂C₆H₄OCF₃ | H | CF₃ | H | CF₃ | 6-Cl |
| A-1090 | CH₂CH═CH₂ | H | CF₃ | H | CF₃ | 6-Cl |
| A-1091 | cyclo-C₃H₅ | H | CF₃ | H | CF₃ | 6-Cl |
| A-1092 | (CH₂)₂NHCH₃ | H | CF₃ | H | CF₃ | 6-Cl |
| A-1093 | H | H | CF₃ | H | Cl | 6-Cl |
| A-1094 | CH₃ | CH₃ | CF₃ | H | Cl | 6-Cl |
| A-1095 | CH₂CH₃ | CH₂CH₃ | CF₃ | H | Cl | 6-Cl |
| A-1096 | CH₃ | H | CF₃ | H | Cl | 6-Cl |
| A-1097 | CH₂CH₃ | H | CF₃ | H | Cl | 6-Cl |
| A-1098 | (CH₂)₂CH₃ | H | CF₃ | H | Cl | 6-Cl |
| A-1099 | CH(CH₃)₂ | H | CF₃ | H | Cl | 6-Cl |
| A-1100 | CH₂CF₃ | H | CF₃ | H | Cl | 6-Cl |
| A-1101 | C(CH₃)₃ | H | CF₃ | H | Cl | 6-Cl |
| A-1102 | CH₂CH(CH₃)₂ | H | CF₃ | H | Cl | 6-Cl |
| A-1103 | CH(CH₃)CH₂CH₃ | H | CF₃ | H | Cl | 6-Cl |
| A-1104 | (CH₂)₂OCH₃ | H | CF₃ | H | Cl | 6-Cl |
| A-1105 | CH₂CH(OCH₃)₂ | H | CF₃ | H | Cl | 6-Cl |
| A-1106 | CH₂CH(OCH₂CH₃)₂ | H | CF₃ | H | Cl | 6-Cl |
| A-1107 | CH₂C₆H₅ | H | CF₃ | H | Cl | 6-Cl |
| A-1108 | CH(CH₃)C₆H₅ | H | CF₃ | H | Cl | 6-Cl |
| A-1109 | (CH₂)₂OC₆H₅ | H | CF₃ | H | Cl | 6-Cl |
| A-1110 | (CH₂)₂C₆H₅ | H | CF₃ | H | Cl | 6-Cl |
| A-1111 | (CH₂)₂C₆H₄F | H | CF₃ | H | Cl | 6-Cl |
| A-1112 | (CH₂)₂C₆H₄Cl | H | CF₃ | H | Cl | 6-Cl |
| A-1113 | (CH₂)₂C₆H₄CN | H | CF₃ | H | Cl | 6-Cl |
| A-1114 | (CH₂)₂C₆H₄CH₃ | H | CF₃ | H | Cl | 6-Cl |
| A-1115 | (CH₂)₂C₆H₄CF₃ | H | CF₃ | H | Cl | 6-Cl |
| A-1116 | (CH₂)₂C₆H₄OCH₃ | H | CF₃ | H | Cl | 6-Cl |
| A-1117 | (CH₂)₂C₆H₄OCF₃ | H | CF₃ | H | Cl | 6-Cl |
| A-1118 | CH₂CH═CH₂ | H | CF₃ | H | Cl | 6-Cl |
| A-1119 | cyclo-C₃H₅ | H | CF₃ | H | Cl | 6-Cl |
| A-1120 | (CH₂)₂NHCH₃ | H | CF₃ | H | Cl | 6-Cl |
| A-1121 | H | H | CF₃ | H | Cl | 6-CF₃ |
| A-1122 | CH₃ | CH₃ | CF₃ | H | Cl | 6-CF₃ |
| A-1123 | CH₂CH₃ | CH₂CH₃ | CF₃ | H | Cl | 6-CF₃ |
| A-1124 | CH₃ | H | CF₃ | H | Cl | 6-CF₃ |
| A-1125 | CH₂CH₃ | H | CF₃ | H | Cl | 6-CF₃ |
| A-1126 | (CH₂)₂CH₃ | H | CF₃ | H | Cl | 6-CF₃ |
| A-1127 | CH(CH₃)₂ | H | CF₃ | H | Cl | 6-CF₃ |
| A-1128 | CH₂CF₃ | H | CF₃ | H | Cl | 6-CF₃ |
| A-1129 | C(CH₃)₃ | H | CF₃ | H | Cl | 6-CF₃ |
| A-1130 | CH₂CH(CH₃)₂ | H | CF₃ | H | Cl | 6-CF₃ |
| A-1131 | CH(CH₃)CH₂CH₃ | H | CF₃ | H | Cl | 6-CF₃ |
| A-1132 | (CH₂)₂OCH₃ | H | CF₃ | H | Cl | 6-CF₃ |
| A-1133 | CH₂CH(OCH₃)₂ | H | CF₃ | H | Cl | 6-CF₃ |
| A-1134 | CH₂CH(OCH₂CH₃)₂ | H | CF₃ | H | Cl | 6-CF₃ |
| A-1135 | CH₂C₆H₅ | H | CF₃ | H | Cl | 6-CF₃ |
| A-1136 | CH(CH₃)C₆H₅ | H | CF₃ | H | Cl | 6-CF₃ |
| A-1137 | (CH₂)₂OC₆H₅ | H | CF₃ | H | Cl | 6-CF₃ |
| A-1138 | (CH₂)₂C₆H₅ | H | CF₃ | H | Cl | 6-CF₃ |
| A-1139 | (CH₂)₂C₆H₄F | H | CF₃ | H | Cl | 6-CF₃ |
| A-1140 | (CH₂)₂C₆H₄Cl | H | CF₃ | H | Cl | 6-CF₃ |
| A-1141 | (CH₂)₂C₆H₄CN | H | CF₃ | H | Cl | 6-CF₃ |
| A-1142 | (CH₂)₂C₆H₄CH₃ | H | CF₃ | H | Cl | 6-CF₃ |
| A-1143 | (CH₂)₂C₆H₄CF₃ | H | CF₃ | H | Cl | 6-CF₃ |
| A-1144 | (CH₂)₂C₆H₄OCH₃ | H | CF₃ | H | Cl | 6-CF₃ |
| A-1145 | (CH₂)₂C₆H₄OCF₃ | H | CF₃ | H | Cl | 6-CF₃ |
| A-1146 | CH₂CH═CH₂ | H | CF₃ | H | Cl | 6-CF₃ |
| A-1147 | cyclo-C₃H₅ | H | CF₃ | H | Cl | 6-CF₃ |
| A-1148 | (CH₂)₂NHCH₃ | H | CF₃ | H | Cl | 6-CF₃ |
| A-1149 | H | H | F | H | CF₃ | 6-Cl |
| A-1150 | CH₃ | CH₃ | F | H | CF₃ | 6-Cl |
| A-1151 | CH₂CH₃ | CH₂CH₃ | F | H | CF₃ | 6-Cl |
| A-1152 | CH₃ | H | F | H | CF₃ | 6-Cl |
| A-1153 | CH₂CH₃ | H | F | H | CF₃ | 6-Cl |
| A-1154 | (CH₂)₂CH₃ | H | F | H | CF₃ | 6-Cl |
| A-1155 | CH(CH₃)₂ | H | F | H | CF₃ | 6-Cl |
| A-1156 | CH₂CF₃ | H | F | H | CF₃ | 6-Cl |
| A-1157 | C(CH₃)₃ | H | F | H | CF₃ | 6-Cl |
| A-1158 | CH₂CH(CH₃)₂ | H | F | H | CF₃ | 6-Cl |
| A-1159 | CH(CH₃)CH₂CH₃ | H | F | H | CF₃ | 6-Cl |
| A-1160 | (CH₂)₂OCH₃ | H | F | H | CF₃ | 6-Cl |
| A-1161 | CH₂CH(OCH₃)₂ | H | F | H | CF₃ | 6-Cl |
| A-1162 | CH₂CH(OCH₂CH₃)₂ | H | F | H | CF₃ | 6-Cl |
| A-1163 | CH₂C₆H₅ | H | F | H | CF₃ | 6-Cl |
| A-1164 | CH(CH₃)C₆H₅ | H | F | H | CF₃ | 6-Cl |
| A-1165 | (CH₂)₂OC₆H₅ | H | F | H | CF₃ | 6-Cl |
| A-1166 | (CH₂)₂C₆H₅ | H | F | H | CF₃ | 6-Cl |
| A-1167 | (CH₂)₂C₆H₄F | H | F | H | CF₃ | 6-Cl |
| A-1168 | (CH₂)₂C₆H₄Cl | H | F | H | CF₃ | 6-Cl |
| A-1169 | (CH₂)₂C₆H₄CN | H | F | H | CF₃ | 6-Cl |
| A-1170 | (CH₂)₂C₆H₄CH₃ | H | F | H | CF₃ | 6-Cl |
| A-1171 | (CH₂)₂C₆H₄CF₃ | H | F | H | CF₃ | 6-Cl |
| A-1172 | (CH₂)₂C₆H₄OCH₃ | H | F | H | CF₃ | 6-Cl |
| A-1173 | (CH₂)₂C₆H₄OCF₃ | H | F | H | CF₃ | 6-Cl |
| A-1174 | CH₂CH═CH₂ | H | F | H | CF₃ | 6-Cl |
| A-1175 | cyclo-C₃H₅ | H | F | H | CF₃ | 6-Cl |
| A-1176 | (CH₂)₂NHCH₃ | H | F | H | CF₃ | 6-Cl |
| A-1177 | H | H | F | H | F | 6-F |
| A-1178 | CH₃ | CH₃ | F | H | F | 6-F |
| A-1179 | CH₂CH₃ | CH₂CH₃ | F | H | F | 6-F |
| A-1180 | CH₃ | H | F | H | F | 6-F |
| A-1181 | CH₂CH₃ | H | F | H | F | 6-F |
| A-1182 | (CH₂)₂CH₃ | H | F | H | F | 6-F |
| A-1183 | CH(CH₃)₂ | H | F | H | F | 6-F |
| A-1184 | CH₂CF₃ | H | F | H | F | 6-F |
| A-1185 | C(CH₃)₃ | H | F | H | F | 6-F |
| A-1186 | CH₂CH(CH₃)₂ | H | F | H | F | 6-F |
| A-1187 | CH(CH₃)CH₂CH₃ | H | F | H | F | 6-F |
| A-1188 | (CH₂)₂OCH₃ | H | F | H | F | 6-F |
| A-1189 | CH₂CH(OCH₃)₂ | H | F | H | F | 6-F |
| A-1190 | CH₂CH(OCH₂CH₃)₂ | H | F | H | F | 6-F |
| A-1191 | CH₂C₆H₅ | H | F | H | F | 6-F |
| A-1192 | CH(CH₃)C₆H₅ | H | F | H | F | 6-F |
| A-1193 | (CH₂)₂OC₆H₅ | H | F | H | F | 6-F |
| A-1194 | (CH₂)₂C₆H₅ | H | F | H | F | 6-F |
| A-1195 | (CH₂)₂C₆H₄F | H | F | H | F | 6-F |
| A-1196 | (CH₂)₂C₆H₄Cl | H | F | H | F | 6-F |
| A-1197 | (CH₂)₂C₆H₄CN | H | F | H | F | 6-F |
| A-1198 | (CH₂)₂C₆H₄CH₃ | H | F | H | F | 6-F |
| A-1199 | (CH₂)₂C₆H₄CF₃ | H | F | H | F | 6-F |
| A-1200 | (CH₂)₂C₆H₄OCH₃ | H | F | H | F | 6-F |
| A-1201 | (CH₂)₂C₆H₄OCF₃ | H | F | H | F | 6-F |
| A-1202 | CH₂CH═CH₂ | H | F | H | F | 6-F |
| A-1203 | cyclo-C₃H₅ | H | F | H | F | 6-F |
| A-1204 | (CH₂)₂NHCH₃ | H | F | H | F | 6-F |
| A-1205 | H | H | Cl | Cl | Cl | 5,6-Cl₂ |
| A-1206 | CH₃ | CH₃ | Cl | Cl | Cl | 5,6-Cl₂ |
| A-1207 | CH₂CH₃ | CH₂CH₃ | Cl | Cl | Cl | 5,6-Cl₂ |
| A-1208 | CH₃ | H | Cl | Cl | Cl | 5,6-Cl₂ |
| A-1209 | CH₂CH₃ | H | Cl | Cl | Cl | 5,6-Cl₂ |
| A-1210 | (CH₂)₂CH₃ | H | Cl | Cl | Cl | 5,6-Cl₂ |
| A-1211 | CH(CH₃)₂ | H | Cl | Cl | Cl | 5,6-Cl₂ |
| A-1212 | CH₂CF₃ | H | Cl | Cl | Cl | 5,6-Cl₂ |
| A-1213 | C(CH₃)₃ | H | Cl | Cl | Cl | 5,6-Cl₂ |
| A-1214 | CH₂CH(CH₃)₂ | H | Cl | Cl | Cl | 5,6-Cl₂ |
| A-1215 | CH(CH₃)CH₂CH₃ | H | Cl | Cl | Cl | 5,6-Cl₂ |
| A-1216 | (CH₂)₂OCH₃ | H | Cl | Cl | Cl | 5,6-Cl₂ |
| A-1217 | CH₂CH(OCH₃)₂ | H | Cl | Cl | Cl | 5,6-Cl₂ |
| A-1218 | CH₂CH(OCH₂CH₃)₂ | H | Cl | Cl | Cl | 5,6-Cl₂ |
| A-1219 | CH₂C₆H₅ | H | Cl | Cl | Cl | 5,6-Cl₂ |
| A-1220 | CH(CH₃)C₆H₅ | H | Cl | Cl | Cl | 5,6-Cl₂ |
| A-1221 | (CH₂)₂OC₆H₅ | H | Cl | Cl | Cl | 5,6-Cl₂ |
| A-1222 | (CH₂)₂C₆H₅ | H | Cl | Cl | Cl | 5,6-Cl₂ |
| A-1223 | (CH₂)₂C₆H₄F | H | Cl | Cl | Cl | 5,6-Cl₂ |
| A-1224 | (CH₂)₂C₆H₄Cl | H | Cl | Cl | Cl | 5,6-Cl₂ |
| A-1225 | (CH₂)₂C₆H₄CN | H | Cl | Cl | Cl | 5,6-Cl₂ |
| A-1226 | (CH₂)₂C₆H₄CH₃ | H | Cl | Cl | Cl | 5,6-Cl₂ |
| A-1227 | (CH₂)₂C₆H₄CF₃ | H | Cl | Cl | Cl | 5,6-Cl₂ |
| A-1228 | (CH₂)₂C₆H₄OCH₃ | H | Cl | Cl | Cl | 5,6-Cl₂ |
| A-1229 | (CH₂)₂C₆H₄OCF₃ | H | Cl | Cl | Cl | 5,6-Cl₂ |
| A-1230 | CH₂CH═CH₂ | H | Cl | Cl | Cl | 5,6-Cl₂ |
| A-1231 | cyclo-C₃H₅ | H | Cl | Cl | Cl | 5,6-Cl₂ |
| A-1232 | (CH₂)₂NHCH₃ | H | Cl | Cl | Cl | 5,6-Cl₂ |
| A-1233 | H | H | F | F | F | 5,6-F₂ |
| A-1234 | CH₃ | CH₃ | F | F | F | 5,6-F₂ |
| A-1235 | CH₂CH₃ | CH₂CH₃ | F | F | F | 5,6-F₂ |
| A-1236 | CH₃ | H | F | F | F | 5,6-F₂ |
| A-1237 | CH₂CH₃ | H | F | F | F | 5,6-F₂ |
| A-1238 | (CH₂)₂CH₃ | H | F | F | F | 5,6-F₂ |
| A-1239 | CH(CH₃)₂ | H | F | F | F | 5,6-F₂ |
| A-1240 | CH₂CF₃ | H | F | F | F | 5,6-F₂ |
| A-1241 | C(CH₃)₃ | H | F | F | F | 5,6-F₂ |
| A-1242 | CH₂CH(CH₃)₂ | H | F | F | F | 5,6-F₂ |
| A-1243 | CH(CH₃)CH₂CH₃ | H | F | F | F | 5,6-F₂ |
| A-1244 | (CH₂)₂OCH₃ | H | F | F | F | 5,6-F₂ |
| A-1245 | CH₂CH(OCH₃)₂ | H | F | F | F | 5,6-F₂ |
| A-1246 | CH₂CH(OCH₂CH₃)₂ | H | F | F | F | 5,6-F₂ |
| A-1247 | CH₂C₆H₅ | H | F | F | F | 5,6-F₂ |
| A-1248 | CH(CH₃)C₆H₅ | H | F | F | F | 5,6-F₂ |
| A-1249 | (CH₂)₂OC₆H₅ | H | F | F | F | 5,6-F₂ |
| A-1250 | (CH₂)₂C₆H₅ | H | F | F | F | 5,6-F₂ |
| A-1251 | (CH₂)₂C₆H₄F | H | F | F | F | 5,6-F₂ |
| A-1252 | (CH₂)₂C₆H₄Cl | H | F | F | F | 5,6-F₂ |
| A-1253 | (CH₂)₂C₆H₄CN | H | F | F | F | 5,6-F₂ |
| A-1254 | (CH₂)₂C₆H₄CH₃ | H | F | F | F | 5,6-F₂ |
| A-1255 | (CH₂)₂C₆H₄CF₃ | H | F | F | F | 5,6-F₂ |
| A-1256 | (CH₂)₂C₆H₄OCH₃ | H | F | F | F | 5,6-F₂ |
| A-1257 | (CH₂)₂C₆H₄OCF₃ | H | F | F | F | 5,6-F₂ |
| A-1258 | CH₂CH═CH₂ | H | F | F | F | 5,6-F₂ |
| A-1259 | cyclo-C₃H₅ | H | F | F | F | 5,6-F₂ |
| A-1260 | (CH₂)₂NHCH₃ | H | F | F | F | 5,6-F₂ |

With respect to the intended use in the present invention, a specific embodiment relates to the compounds of the formula I-B

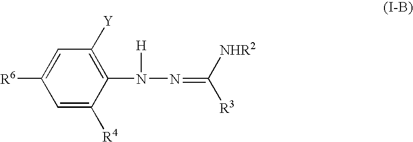

wherein
R⁶ is chlorine or trifluoromethyl;
R⁴ and Y are each independently chlorine or bromine;
R² is C₁-C₆-alkyl, C₃-C₆-alkenyl, C₃-C₆-alkynyl, or C₃-C₆-cycloalkyl which is unsubstituted or substituted with 1 to 3 halogen atoms, or C₂-C₄-alkyl which is substituted by C₁-C₄-alkoxy; and
R³ is C₁-C₆-alkyl or a cyclopropyl group of formula II as defined herein wherein R⁷ is hydrogen, C₁-C₆-alkyl or C₁-C₆-haloalkyl, and R⁸, R⁹, R¹⁰ and R¹¹ are each independently selected from hydrogen, halogen, C₁-C₆-alkyl and C₁-C₆-haloalkyl.

In a further embodiment of the compounds of formula I-B, R⁶ is trifluoromethyl.

In a further embodiment of the compounds I-B, Y and R⁴ are both chlorine.

In a further embodiment of the compounds I-B, R² is C₁-C₆-alkyl, especially ethyl.

In a further embodiment of the compounds I-B, R³ is C₁-C₆-alkyl, in particular tert-butyl.

In a further embodiment of the compounds I-B, R³ is cyclopropyl which is unsubstituted or substituted by 1 to 3 halogen atoms.

In a further embodiment of the compounds I-B, R³ is cyclopropyl which is substituted by 2 halogen atoms, especially chlorine and bromine, and 1 C₁-C₆-alkyl group, especially methyl.

In a further embodiment of the compounds I-B, R³ is a cyclopropyl group of formula II wherein R⁷ is hydrogen, C₁-C₆-alkyl or C₁-C₆-haloalkyl, R⁸ and R⁹ are both halogen, and R¹⁰ and R¹¹ are both hydrogen.

In a further embodiment of the compounds I-B, R³ is a cyclopropyl group of formula II wherein R⁷ is C₁-C₆-alkyl, R⁸ and R⁹ are both halogen, and R¹⁰ and R¹¹ are both hydrogen.

In a further embodiment of the compounds I-B, R³ is a cyclopropyl group of formula II wherein R⁷ is hydrogen, methyl or trifluoromethyl, R⁸ and R⁹ are independently selected from fluoro, chloro and bromo, and R¹⁰ and R¹¹ are both hydrogen.

In a further embodiment of the compounds I-B, R³ is a cyclopropyl group of formula II wherein R⁷ is hydrogen or methyl, R⁸ and R⁹ are chloro or bromo, and R¹⁰ and R¹¹ are both hydrogen.

In a further embodiment of the compounds I-B, R³ is a cyclopropyl group of formula II wherein R⁷ is methyl, R⁸ and R⁹ are chloro or bromo, and R¹⁰ and R¹¹ are both hydrogen.

In a further embodiment of the compounds I-B, R³ is a cyclopropyl group of formula II wherein R⁷ is methyl, R⁸ and R⁹ are both chloro, and R¹⁰ and R¹¹ are both hydrogen, i.e. 1-(2,2-dichloro-1-methylcyclopropyl).

In a further embodiment of the compounds I-B,

R⁶ is trifluoromethyl;

Y and R⁴ are each independently chlorine or bromine;

R² is C₁-C₆-alkyl;

R³ is C₁-C₆-alkyl or C₃-C₆-cycloalkyl which is substituted by 1 or 2 halogen atoms and 1 C₁-C₆-alkyl.

With respect to the use in the present invention, another specific embodiment relates to the compound of formula I-1 (N-ethyl-2,2-dimethylpropionamide-2-(2,6-dichloro-α,α,α-trifluoro-p-tolyl)-hydrazone):

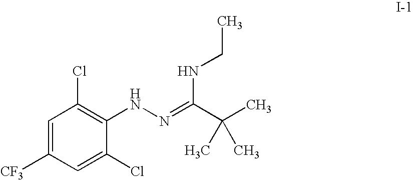

Yet another specific embodiment of the present invention relates to the compound of formula I-2 (N-Ethyl-2,2-dichloro-1-methylcyclopropane-carboxamide-2-(2,6-dichloro-α,α,α-trifluoro-p-tolyl)hydrazone):

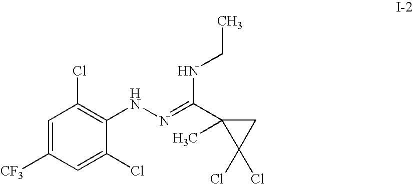

In another embodiment, agrochemically acceptable salts of the compounds of formula I, can be used in the present invention, such as, for example, conventional salts formed from suitable organic or inorganic acids. Examples of agrochemically acceptable salts of the compounds of formula I include chlorides, bromides, fluorides, hydrogen sulfates, sulfates, dihydrogen phosphates, hydrogen phosphates, phosphates, nitrates, hydrogen carbonates, carbonates, hexafluorosilicates, hexafluorophosphates, benzoates, and the salts of C₁-C₄-alkanoic acids, preferably formates, acetates, propionates and butyrates. The scope of the present invention includes isomers of the amidrazones of formula I as defined herein. The term “isomer” is used herein in its broadest sense to include structural isomers (such as, for example, positional isomers and tautomers) and stereoisomers (such as, for example, optical isomers, rotational isomers and E/Z isomers). In cases where the amidrazones of formula I possess asymmetric carbon atoms, the racemates and diastereomers as well as the individual enantiometric forms of the amidrazones I as described herein also form part of the scope of the present invention.

The compounds of formula I are suitable as fungicides. They are distinguished by an outstanding effectiveness against a broad spectrum of phytopathogenic fungi, especially from the classes of the Ascomycetes, Basidiomycetes, Deuteromycetes and Peronosporomycetes (syn. Oomycetes). The compounds of formula I are particularly effective against Basidiomycete and Oomycete plant pathogens. Some are systemically effective and they can be used in crop protection as foliar fungicides, fungicides for seed dressing and soil fungicides.

They are particularly important in the control of a multitude of fungi on various cultivated plants, such as wheat, rye, barley, oats, rice, corn, lawns, bananas, cotton, soybeans, coffee, sugar cane, grapevines, fruit and ornamental plants, and vegetables, such as cucumbers, beans, tomatoes, potatoes and cucurbits, and on the seeds of these plants.

The compounds I and compositions thereof are particularly suitable for controlling the following plant diseases:

Albugo spp. (white rust) on ornamentals, vegetables (e. g. A. candida) and sunflowers (e. g. A. tragopogonis),

Alternaria spp. (Alternaria leaf spot) on vegetables, rape (A. brassicola or brassicae), sugar beets (A. tenuis), fruits, rice, soybeans, potatoes (e. g. A. solani or A. alternata), tomatoes (e. g. A. solani or A. alternata) and wheat,

Aphanomyces spp. on sugar beets and vegetables,

Ascochyta species on cereals and vegetables, e. g. A. tritici (anthracnose) on wheat and A. hordei on barley

Bipolaris and Drechslera spp. (Teleomorph: Cochliobolus spp.) on corn (e. g. D. maydis), cereals (e. g. B. sorokiniana: spot blotch), rice (e. g. B. oryzae) and turfs,

Blumeria (formerly Erysiphe) graminis (powdery mildew) on cereals (e. g. on wheat or barley),

Botrytis cinerea (teleomorph: Botryotinia fuckeliana: grey mold) on fruits and berries (e. g. strawberries), vegetables (e. g. lettuce, carrots, celery and cabbages), rape, flowers, vines, forestry plants and wheat,

Bremia lactucae (downy mildew) on lettuce,

Ceratocystis (syn. Ophiostoma) spp. (rot or wilt) on broad-leaved trees and evergreens, e. g. C. ulmi (Dutch elm disease) on elms,

Cercospora spp. (Cercospora leaf spots) on corn, rice, sugar beets (e. g. C. beticola), sugar cane, vegetables, coffee, soybeans (e. g. C. sojina or C. kikuchii) and rice,

Cladosporium spp. on tomatoes (e. g. C. fulvum: leaf mold) and cereals, e. g. C. herbarum (black ear) on wheat,

Claviceps purpurea (ergot) on cereals,

Cochliobolus (anamorph: Helminthosporium of Bipolaris) spp. (leaf spots) on corn (C. carbonum), cereals (e. g. C. sativus, anamorph: B. sorokiniana) and rice (e. g. C. miyabeanus, anamorph: H. oryzae),

Colletotrichum (teleomorph: Glomerella) spp. (anthracnose) on cotton (e. g. C. gossypii), corn (e. g. C. graminicola), soft fruits, potatoes (e. g. C. coccodes: black dot), beans (e. g. C. lindemuthianum) and soybeans (e. g. C. truncatum),

Corticium spp., e. g. C. sasakii (sheath blight) on rice,

Corynespora cassiicola (leaf spots) on soybeans and ornamentals,

Cycloconium spp., e. g. C. oleaginum on olive trees,

Cylindrocarpon spp. (e. g. fruit tree canker or young vine decline, teleomorph: Nectria or Neonectria spp.) on fruit trees, vines (e. g. C. liriodendri, teleomorph: Neonectria liriodendri: Black Foot Disease) and ornamentals,

Dematophora (teleomorph: Rosellinia) necatrix (root and stem rot) on soybeans,

Diaporthe spp., e. g. D. phaseolorum (damping off) on soybeans,

Drechslera (syn. Helminthosporium, teleomorph: Pyrenophora) spp. on corn, cereals, such as barley (e. g. D. teres, net blotch) and wheat (e. g. D. tritici-repentis: tan spot), rice and turf,

Esca (dieback, apoplexy) on vines, caused by Formitiporia (syn. Phellinus) punctata, F. mediterranea, Phaeomoniella chlamydospora (earlier Phaeoacremonium chlamydosporum), Phaeoacremonium aleophilum and/or Botryosphaeria obtusa,

Elsinoe spp. on pome fruits (E. pyri), soft fruits (E. veneta: anthracnose) and vines (E. ampelina: anthracnose),

Entyloma oryzae (leaf smut) on rice,

Epicoccum spp. (black mold) on wheat,

Erysiphe spp. (powdery mildew) on sugar beets (E. betae), vegetables (e. g. E. pisi), such as cucurbits (e. g. E. cichoracearum), cabbages, rape (e. g. E. cruciferarum),

Eutypa lata (Eutypa canker or dieback, anamorph: Cytosporina lata, syn. Libertella blepharis) on fruit trees, vines and ornamental woods,

Exserohilum (syn. Helminthosporium) spp. on corn (e. g. E. turcicum),

Fusarium (teleomorph: Gibberella) spp. (wilt, root or stem rot) on various plants, such as F. graminearum or F. culmorum (root rot, scab or head blight) on cereals (e. g. wheat or barley), F. oxysporum on tomatoes, F. solani on soybeans and F. verticillioides on corn,

Gaeumannomyces graminis (take-all) on cereals (e. g. wheat or barley) and corn,

Gibberella spp. on cereals (e. g. G. zeae) and rice (e. g. G. fujikuroi: Bakanae disease),

Glomerella cingulata on vines, pome fruits and other plants and G. gossypii on cotton, Grainstaining complex on rice,

Guignardia bidwellii (black rot) on vines,

Gymnosporangium spp. on rosaceous plants and junipers, e. g. G. sabinae (rust) on pears,

Helminthosporium spp. (syn. Drechslera, teleomorph: Cochliobolus) on corn, cereals and rice,

Hemileia spp., e. g. Hemileia vastatrix (coffee leaf rust) on coffee,

Isariopsis clavispora (syn. Cladosporium vitis) on vines,

Macrophomina phaseolina (syn. phaseoli) (root and stem rot) on soybeans and cotton,

Microdochium (syn. Fusarium) nivale (pink snow mold) on cereals (e. g. wheat or barley),

Microsphaera diffusa (powdery mildew) on soybeans,

Monilinia spp., e. g. M. laxa, M. fructicola and M. fructigena (bloom and twig blight, brown rot) on stone fruits and other rosaceous plants,

Mycosphaerella spp. on cereals, bananas, soft fruits and ground nuts, such as e. g. M. graminicola (anamorph: Septoria tritici, Septoria blotch) on wheat or M. fijiensis (black Sigatoka disease) on bananas,

Peronospora spp. (downy mildew) on cabbage (e. g. P. brassicae), rape (e. g. P. parasitica), onions (e. g. P. destructor), tobacco (P. tabacina) and soybeans (e. g. P. manshurica),

Phakopsora pachyrhizi and P. meibomiae (soybean rust) on soybeans,

Phialophora spp. e. g. on vines (e. g. P. tracheiphila and P. tetraspora) and soybeans (e. g. P. gregata: stem rot),

Phoma lingam (root and stem rot) on rape and cabbage and P. betae (root rot, leaf spot and damping-off) on sugar beets,

Phomopsis spp. on sunflowers, vines (e. g. P. viticola: can and leaf spot) and soybeans (e. g. stem rot: P. phaseoli, teleomorph: Diaporthe phaseolorum),

Physorma maydis (brown spots) on corn,

Phytophthora spp. (wilt, root, leaf, fruit and stem root) on various plants, such as paprika and cucurbits (e. g. P. capsici), soybeans (e. g. P. megasperma, syn. P. sojae), potatoes and tomatoes (e. g. P. infestans: late blight) and broad-leaved trees (e. g. P. ramorum: sudden oak death)

Plasmodiophora brassicae (club root) on cabbage, rape, radish and other plants,

Plasmopara spp., e. g. P. viticola (grapevine downy mildew) on vines and P. halstedii on sunflowers,

Podosphaera spp. (powdery mildew) on rosaceous plants, hop, pome and soft fruits, e. g. P. leucotricha on apples,

Polymyxa spp., e. g. on cereals, such as barley and wheat (P. graminis) and sugar beets (P. betae) and thereby transmitted viral diseases,

Pseudocercosporella herpotrichoides (eyespot, teleomorph: Tapesia yallundae) on cereals, e. g. wheat or barley,

Pseudoperonospora (downy mildew) on various plants, e. g. P. cubensis on cucurbits or P. humili on hop,

Pseudopezicula tracheiphila (red fire disease or, rotbrenner', anamorph: Phialophora) on vines,

Puccinia spp. (rusts) on various plants, e. g. P. triticina (brown or leaf rust), P. striiformis (stripe or yellow rust), P. hordei (dwarf rust), P. graminis (stem or black rust) or

P. recondita (brown or leaf rust) on cereals, such as e. g. wheat, barley or rye, and asparagus (e. g. P. asparagi),

Pyrenophora (anamorph: Drechslera) tritici-repentis (tan spot) on wheat or P. teres (net blotch) on barley,

Pyricularia spp., e. g. P. oryzae (teleomorph: Magnaporthe grisea, rice blast) on rice and P. grisea on turf and cereals,

Pythium spp. (damping-off) on turf, rice, corn, wheat, cotton, rape, sunflowers, sugar beets, vegetables and various other plants (e. g. P. ultimum or P. aphanidermatum),

Ramularia spp., e. g. R. collo-cygni (Ramularia leaf spots, Physiological leaf spots) on barley and R. beticola on sugar beets,

Rhizoctonia spp. on cotton, rice, potatoes, turf, corn, rape, potatoes, sugar beets, vegetables and various other plants, e. g. R. solani (root and stem rot) on soybeans, R. solani (sheath blight) on rice or R. cerealis (Rhizoctonia spring blight) on wheat or barley,

Rhizopus stolonifer (black mold, soft rot) on strawberries, carrots, cabbage, vines and tomatoes,

Rhynchosporium secalis (scald) on barley, rye and triticale,

Sarocladium oryzae and S. attenuatum (sheath rot) on rice,

Sclerotinia spp. (stem rot or white mold) on vegetables and field crops, such as rape, sunflowers (e. g. S. sclerotiorum) and soybeans (e. g. S. rolfsii),

Septoria spp. on various plants, e. g. S. glycines (brown spot) on soybeans, S. tritici (Septoria blotch) on wheat and S. (syn. Stagonospora) nodorum (Stagonospora blotch) on cereals,

Uncinula (syn. Erysiphe) necator (powdery mildew, anamorph: Oidium tuckeri) on vines,

Setospaeria spp. (leaf blight) on corn (e. g. S. turcicum, syn. Helminthosporium turcicum) and turf,

Sphacelotheca spp. (smut) on corn, (e. g. S. reiliana: head smut), sorghum and sugar cane,

Sphaerotheca fuliginea (powdery mildew) on cucurbits,

Spongospora subterranea (powdery scab) on potatoes and thereby transmitted viral diseases,

Stagonospora spp. on cereals, e. g. S. nodorum (Stagonospora blotch, teleomorph: Leptosphaeria [syn. Phaeosphaeria] nodorum) on wheat,

Synchytrium endobioticum on potatoes (potato wart disease),

Taphrina spp., e. g. T. deformans (leaf curl disease) on peaches and T. pruni (plum pocket) on plums,

Thielaviopsis spp. (black root rot) on tobacco, pome fruits, vegetables, soybeans and cotton, e. g. T. basicola (syn. Chalara elegans),

Tilletia spp. (common bunt or stinking smut) on cereals, such as e. g. T. tritici (syn. T. caries, wheat bunt) and T. controversa (dwarf bunt) on wheat,

Typhula incarnata (grey snow mold) on barley or wheat,

Urocystis spp., e. g. U. occulta (stem smut) on rye,

Uromyces spp. (rust) on vegetables, such as beans (e. g. U. appendiculatus, syn. U. phaseoli) and sugar beets (e. g. U. betae),

Ustilago spp. (loose smut) on cereals (e. g. U. nuda and U. avaenae), corn (e. g. U. maydis: corn smut) and sugar cane,

Venturia spp. (scab) on apples (e. g. V. inaequalis) and pears,

Verticillium spp. (wilt) on various plants, such as fruits and ornamentals, vines, soft fruits, vegetables and field crops, e. g. V. dahliae on strawberries, rape, potatoes and tomatoes.

The compounds I are also suitable for controlling harmful fungi in the protection of materials (e.g. wood, paper, paint dispersions, fiber or fabrics) and in the protection of stored products. In the protection of wood, particular attention is paid to the following harmful fungi: Ascomycetes, such as Ophiostoma spp., Ceratocystis spp., Aureobasidium pullulans, Sclerophoma spp., Chaetomium spp., Humicola spp., Petriella spp., Trichurus spp.; Basidiomycetes, such as Coniophora spp., Coriolus spp., Gloeophyllum spp., Lentinus spp., Pleurotus spp., Poria spp., Serpula spp. and Tyromyces spp., Deuteromycetes, such as Aspergillus spp., Cladosporium spp., Penicillium spp., Trichoderma spp., Alternaria spp., Paecilomyces spp. and Zygomycetes, such as Mucor spp., additionally in the protection of materials the following yeasts: Candida spp. and Saccharomyces cerevisae.

The compounds I are employed by treating the fungi or the plants, seeds, materials or the soil to be protected from fungal attack with a fungicidally effective amount of the active compounds. The application can be carried out both before and after the infection of the materials, plants or seeds by the fungi.

The fungicidal compositions generally comprise between 0.1 and 95%, preferably between 0.5 and 90%, by weight of active compound. The active compounds are employed in a purity of from 90% to 100%, preferably from 95% to 100% (according to NMR spectrum).

When employed in plant protection, the amounts applied are, depending on the kind of effect desired, between 0.01 and 2.0 kg of active compound per ha.

In seed treatment, for example by dusting, coating or drenching seed, amounts of active compound of from 1 to 1000 g, preferably from 5 to 100 g, per 100 kilogram of seed are generally required.

When used in the protection of materials or stored products, the amount of active compound applied depends on the kind of application area and on the desired effect. Amounts customarily applied in the protection of materials are, for example, 0.001 g to 2 kg, preferably 0.005 g to 1 kg, of active compound per cubic meter of treated material.

In addition the compounds of the formula I may also be used in cultures which can tolerate insecticidal or fungal attack due to cultivation, including of genetic engineering.

The compounds I and their salts can be converted into customary formulations (agricultural formulations), e.g. solutions, emulsions, suspensions, dusts, powders, pastes and granules. The application form depends on the particular intended purpose; in each case, it should ensure a fine and uniform distribution of the compound according to the invention.

The formulations are prepared in a known manner, e.g. by extending the active ingredient with solvents and/or carriers, if desired using emulsifiers and dispersants. Solvents/auxiliaries, which are suitable, are essentially:
water, aromatic solvents (for example Solvesso® products, xylene), paraffins (for example mineral fractions), alcohols (for example methanol, butanol, pentanol, benzyl alcohol), ketones (for example cyclohexanone, gamma-butyrolactone), pyrrolidones (N-methylpyrrolidone, N-octylpyrrolidone), acetates (glycol diacetate), glycols, fatty acid dimethylamides, fatty acids and fatty acid esters. In principle, solvent mixtures may also be used.
carriers such as ground natural minerals (e.g. kaolins, clays, talc, chalk) and ground synthetic minerals (e.g. highly disperse silica, silicates); emulsifiers such as nonionic and anionic emulsifiers (e.g. polyoxyethylene fatty alcohol ethers, alkylsulfonates and arylsulfonates) and dispersants such as lignin-sulfite waste liquors and methylcellulose.

Suitable surfactants are alkali metal, alkaline earth metal and ammonium salts of lignosulfonic acid, naphthalenesulfonic acid, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalenesulfonic acid with phenol and formaldehyde, polyoxyethylene octylphenyl ether, ethoxylated isooctylphenol, octylphenol, nonylphenol, alkylphenyl polyglycol ethers, tributylphenyl polyglycol ether, tristearylphenyl polyglycol ether, alkylaryl polyether alcohols, alcohol and fatty alcohol/ethylene oxide condensates, ethoxylated castor oil, polyoxyethylene alkyl ethers, ethoxylated polyoxypropylene, lauryl alcohol polyglycol ether acetal, sorbitol esters, lignin-sulfite waste liquors and methylcellulose.

Substances which are suitable for the preparation of directly sprayable solutions, emulsions, pastes or oil dispersions are mineral oil fractions of medium to high boiling point, such as kerosene or diesel oil, furthermore coal tar oils and oils of vegetable or animal origin, aliphatic, cyclic and aromatic hydrocarbons, for example toluene, xylene, paraffin, tetrahydronaphthalene, alkylated naphthalenes or their derivatives, methanol, ethanol, propanol, butanol, cyclohexanol, cyclohexanone, isophorone, strongly polar solvents, for example dimethyl sulfoxide, N-methylpyrrolidone and water.

Also anti-freezing agents such as glycerin, ethylene glycol and propylene glycol can be added to the formulation.

Suitable antifoaming agents are, for example, those based on silicone or magnesium stearate.

Powders, materials for spreading and dusts can be prepared by mixing or concomitantly grinding the active substances with a solid carrier.

Granules, for example coated granules, impregnated granules and homogeneous granules, can be prepared by binding the active ingredients to solid carriers. Examples of solid carriers are mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, for example, ammonium sulfate, ammonium phosphate, ammonium nitrate, ureas, and products of vegetable origin, such as cereal meal, tree bark meal, wood meal and nutshell meal, cellulose powders and other solid carriers.

Formulations for the treatment of seed may additionally comprise binders and/or gelling agents and, if appropriate, colorants.

Binders may be added to increase the adhesion of the active compounds on the seed after the treatment. Suitable binders are, for example, EO/PO block copolymer surfactants, but also polyvinyl alcohols, polyvinylpyrrolidones, polyacrylates, polymethacrylates, polybutenes, polyisobutylenes, polystyrenes, polyethylenamines, polyethylenamides, polyethylenimines (Lupasol®, Polymin®), polyethers, polyurethanes, polyvinyl acetates, tylose and copolymers of these polymers.

A suitable gelling agent is, for example, carrageen (Satiagel®).

In general, the formulations comprise from 0.01 to 95% by weight, preferably from 0.1 to 90% by weight, of the active compound. The active compounds are employed in a purity of from 90% to 100%, preferably from 95% to 100% (according to NMR spectrum).

The concentrations of active compound in the ready-for-use preparations can be varied within relatively wide ranges. In general, they are between 0.0001 and 10%, preferably between 0.01 and 1%.

The active compounds can also be used with great success in the ultra-low volume (ULV) process, it being possible to apply formulations with more than 95% by weight of active compound or even the active compound without additives.

For the treatment of seed, the formulations in question give, after two-to-tenfold dilution, active compound concentrations of from 0.01 to 60% by weight, preferably from 0.1 to 40% by weight, in the ready-to-use preparations.

The following are examples of formulations: 1. Products for dilution with water

A) Water-Soluble Concentrates (SL, LS)

10 parts by weight of a compound I according to the invention are dissolved in 90 parts by weight of water or in a water-soluble solvent. As an alternative, wetting agents or other auxiliaries are added. The active compound dissolves upon dilution with water. In this way, a formulation having a content of 10% by weight of active compound is obtained.

B) Dispersible Concentrates (DC)

20 parts by weight of a compound I according to the invention are dissolved in 70 parts by weight of cyclohexanone with addition of 10 parts by weight of a dispersant, for example polyvinylpyrrolidone. Dilution with water gives a dispersion. The active compound content is 20% by weight.

C) Emulsifiable Concentrates (EC)

15 parts by weight of a compound I according to the invention are dissolved in 75 parts by weight of xylene with addition of calcium dodecylbenzenesulfonate and castor oil ethoxylate (in each case 5 parts by weight). Dilution with water gives an emulsion. The formulation has an active compound content of 15% by weight.

D) Emulsions (EW, EO, ES)

25 parts by weight of a compound I according to the invention are dissolved in 35 parts by weight of xylene with addition of calcium dodecylbenzenesulfonate and castor oil ethoxylate (in each case 5 parts by weight). This mixture is introduced into 30 parts by weight of water by means of an emulsifying machine (Ultraturrax) and made into a homogeneous emulsion. Dilution with water gives an emulsion. The formulation has an active compound content of 25% by weight.

E) Suspensions (SC, OD, FS)

In an agitated ball mill, 20 parts by weight of a compound I according to the invention are comminuted with addition of 10 parts by weight of dispersants and wetting agents and 70 parts by weight of water or an organic solvent to give a fine active compound suspension. Dilution with water gives a stable suspension of the active compound. The active compound content in the formulation is 20% by weight.

F) Water-Dispersible Granules and Water-Soluble Granules (WG, SG)

50 parts by weight of a compound I according to the invention are ground finely with addition of 50 parts by weight of dispersants and wetting agents and prepared as water-dispersible or water-soluble granules by means of technical appliances (for example extrusion, spray tower, fluidized bed). Dilution with water gives a stable dispersion or solution of the active compound. The formulation has an active compound content of 50% by weight.

G) Water-Dispersible Powders and Water-Soluble Powders (WP, SP, SS, WS)

75 parts by weight of a compound I according to the invention are ground in a rotor-stator mill with addition of 25 parts by weight of dispersants, wetting agents and silica gel. Dilution with water gives a stable dispersion or solution of the active compound. The active compound content of the formulation is 75% by weight.

H) Gel (GF)

In an agitated ball mill, 20 parts by weight of a compound I according to the invention are comminuted with addition of 10 parts by weight of dispersants, 1 part by weight of a gelling agent wetters and 70 parts by weight of water or of an organic solvent to give a fine suspension of the active compound. Dilution with water gives a stable suspension of the active compound, whereby a formulation with 20% (w/w) of active compound is obtained.

2. Products to be Applied Undiluted

J) Dustable Powders (DP, DS)

5 parts by weight of a compound I according to the invention are ground finely and mixed intimately with 95 parts by weight of finely divided kaolin. This gives a dustable product having an active compound content of 5% by weight.

K) Granules (GR, FG, GG, MG)

0.5 part by weight of a compound I according to the invention is ground finely and associated with 99.5 parts by weight of carriers. Current methods are extrusion, spray-drying or the fluidized bed. This gives granules to be applied undiluted having an active compound content of 0.5% by weight.

L) ULV Solutions (UL)

10 parts by weight of a compound I according to the invention are dissolved in 90 parts by weight of an organic solvent, for example xylene. This gives a product to be applied undiluted having an active compound content of 10% by weight.

The active ingredients can be used as such, in the form of their formulations or the use forms prepared therefrom, e.g. in the form of directly sprayable solutions, powders, suspensions or dispersions, emulsions, oil dispersions, pastes, dustable products, materials for spreading, or granules, by means of spraying, atomizing, dusting, spreading or pouring. The use forms depend entirely on the intended purposes; it is intended to ensure in each case the finest possible distribution of the active ingredients according to the invention.

Aqueous use forms can be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of a wetter, tackifier, dispersant or emulsifier. Alternatively, it is possible to prepare concentrates composed of active substance, wetter, tackifier, dispersant or emulsifier and, if appropriate, solvent or oil, and such concentrates are suitable for dilution with water.

The active ingredient concentrations in the ready-to-use products can be varied within relatively wide ranges. In general, they are from 0.0001 to 10%, preferably from 0.001 to 1%.

The active ingredients may also be used successfully in the ultra-low-volume process (ULV), it being possible to apply formulations comprising over 95% by weight of active ingredient, or even to apply the active ingredient without additives.

Various types of oils, wetters, adjuvants, herbicides, fungicides, other pesticides, or bactericides may be added to the active compounds, if appropriate not until immediately prior to use (tank mix). These agents can be admixed with the agents according to the invention in a weight ratio of 1:10 to 10:1.

The compositions according to the invention can, in the use form as fungicides, also be present together with other active compounds, e.g. with herbicides, insecticides, growth regulators, fungicides or else with fertilizers. Mixing the compounds I or the compositions comprising them in the use form as fungicides with at least one fungicidal compound II results in many cases in an expansion of the fungicidal spectrum of activity being obtained.

The following list of fungicidal compounds II, in conjunction with which the compounds of formula I can be used, is intended to illustrate the possible combinations but does not limit them:
A) azoles, in particular: bitertanol, bromuconazole, cyproconazole, difenoconazole, diniconazole, enilconazole, epoxiconazole, fluquinconazole, fenbuconazole, flusilazole, flutriafol, hexaconazole, imibenconazole, ipconazole, metconazole, myclobutanil, penconazole, propiconazole, prothioconazole, simeconazole, triadimefon, triadimenol, tebuconazole, tetraconazole, triticonazole; prochloraz, pefurazoate, imazalil, triflumizole, cyazofamid; benomyl, carbendazim, thiabendazole, fuberidazole; ethaboxam, etridiazole, hymexazole;
B) strobilurins, in particular: azoxystrobin, dimoxystrobin, enestroburin, fluoxastrobin, kresoxim-methyl, metominostrobin, orysastrobin, picoxystrobin, pyraclostrobin, trifloxystrobin, or methyl(2-chloro-5-[1-(3-methylbenzyloxy-imino)ethyl]benzyl)carbamate, methyl(2-chloro-5-[1-(6-methylpyridin-2-yl-methoxyimino)ethypenzyl)carbamate, methyl 2-(ortho-((2,5-dimethylphenyl-oxymethylene)phenyl)-3-methoxyacrylate;
C) carboxamides, in particular: carboxin, benalaxyl, boscalid, fenhexamid, flutolanil, furametpyr, mepronil, metalaxyl, mefenoxam, ofurace, oxadixyl, oxycarboxin, penthiopyrad, thifluzamide, tiadinil, N-(4′-bromobiphenyl-2-yl)-4-difluoromethyl-2-methylthiazole-5-carboxamide, N-(4′-trifluoromethylbiphenyl-2-yl)-4-difluoromethyl-2-methylthiazole-5-carboxamide, N-(4′-chloro-3′-fluorobiphenyl-2-yl)-4-difluoromethyl-2-methylthiazole-5-carboxamide, N-(3′,4′-dichloro-4-fluorobiphenyl-2-yl)-3-difluoromethyl-1-methylpyrazole-4-carboxamide, N-(3′,4′-dichloro-5-fluorobiphenyl-2-yl)-3-difluoromethyl-1-methylpyrazole-4-carboxamide; 3,4-dichloro-N-(2-cyanophenyl)isothiazol-5-carboxamide; dimethomorph, flumorph; flumetover, fluopicolide (picobenzamid), zoxamide; carpropamid, diclocymet, mandipropamid; N-(2-{4-[3-(4-chlorophenyl)prop-2-ynyloxy]-3-methoxyphenyl}ethyl)-2-methane-sulfonylamino-3-methylbutyramide, N-(2-{4-[3-(4-chlorophenyl)-prop-2-ynyloxy]-3-methoxyphenyl}ethyl)-2-ethanesulfonylamino-3-methyl-butyramide;
D) heterocylic compounds, in particular: fluazinam, pyrifenox; bupirimate, cyprodinil, fenarimol, ferimzone, mepanipyrim, nuarimol, pyrimethanil; triforine; fenpiclonil, fludioxonil; aldimorph, dodemorph, fenpropimorph, tridemorph; fenpropidin, iprodione, procymidone, vinclozolin; famoxadone, fenamidone, octhilinone, probenazole; amisulbrom, anilazine, diclomezine, pyroquilon, proquinazid, tricyclazole; 5-chloro-7-(4-methylpiperidin-1-yl)-6-(2,4,6-trifluorophenyl)-[1,2,4]triazolo[1,5-a]pyrimidine, 2-butoxy-6-iodo-3-propylchromen-4-one; acibenzolar-S-methyl, captafol, captan, dazomet, folpet, fenoxanil, quinoxyfen; 3-[5-(4-chlorophenyl)-2,3-dimethylisoxazolidin-3-yl]pyridine;
E) carbamates, in particular: mancozeb, maneb, metam, metiram, ferbam, propineb, thiram, zineb, ziram; diethofencarb, iprovalicarb, flubenthiavalicarb, propamocarb; methyl 3-(4-chlorophenyl)-3-(2-isopropoxycarbonylamino-3-methyl-butyrylamino)propanoate;

and
F) other active compounds, selected from guanidines: dodine, iminoctadine, guazatine; antibiotics: kasugamycin, streptomycin, polyoxine, validamycin A; nitrophenyl derivates: binapacryl, dinocap, dinobuton; sulfur-containing heterocyclyl compounds: dithianon, isoprothiolane; organometal compounds: fentin salts, such as fentin-acetate; organophosphorus compounds: edifenphos, iprobenfos, fosetyl, fosetyl-aluminum, phosphorous acid and its salts, pyrazophos, tolclofos-methyl; organochlorine compounds: chlorothalonil, dichlofluanid, flusulfamide, hexachlorobenzene, phthalide, pencycuron, quintozene, thiophanate-methyl, tolylfluanid; inorganic active compounds: Bordeaux mixture, copper acetate, copper hydroxide, copper oxychloride, basic copper sulfate, sulfur; others: cyflufenamid, cymoxanil, dimethirimol, ethirimol, furalaxyl, metrafenone and spiroxamine.

The fungicidal action of the compounds of the formula I was demonstrated by the following tests:

### USE EXAMPLES

The compound of formula I-2, i.e. N-Ethyl-2,2-dichloro-1-methylcyclopropane-carboxamide-2-(2,6-dichloro-α,α,α-trifluoro-p-tolyl)hydrazone, was dissolved with dimethyl sulfoxide to a concentration of 10000 ppm. The stock solutions were pipetted onto a microtiter plate (MTP) and diluted with water to the stated concentrations. In the case of Phytophthora infestans (see Example 3 in Table I below), a spore suspension of said fungus in a pea juice-based aqueous nutrient medium was then added. In all other tests (see Examples 1, 2 and 4 to 13 in Table I below), a spore suspension of the stated fungus in a 2% aqueous biomalt solution was then added. The plates were placed in a water vapor-saturated chamber at a temperature of 18° C. Using an absorption photometer, the MTPs were measured at 405 nm 7 days after the inoculation. The measured parameters were compared to the growth of the active compound-free control variant (100%) and the fungus-free and active compound-free blank value to determine the relative growth in % of the pathogens in the respective active compounds. These percentages were converted into efficacies. The efficacy (E) was calculated as follows using Abbot's formula:

E=(1−α/β)·100
α corresponds to the fungicidal infection of the treated variant in % and
β corresponds to the fungicidal infection of the active compound-free control variant in %

The results of the tests conducted with the compound of formula I-2 are summarized in Table I below:

TABLE I
Efficacy of compound I-2 against various pathogens at a concentration
of 63 ppm

| Example | Pathogen | Efficacy [%] |
|---|---|---|
| 1 | Colleotrichum lagenarium | 89 |
| 2 | Monographella nivalis | 100 |
| 3 | Phytophthora infestans | 100 |
| 4 | Pseudocercosporella herpotrichoides R-Type | 100 |
| 5 | Pseudocercosporella herpotrichoides W-Type | 100 |
| 6 | Pyricularia oryzae | 91 |
| 7 | Pyrenophora teres | 96 |
| 8 | Rhynchosporium secalis | 100 |
| 9 | Septoria tritici | 100 |
| 10 | Colleotrichum truncatum | 100 |
| 11 | Corynespora cassiicola | 100 |
| 12 | Septoria glycines | 100 |
| 13 | Leptosphaeria nodorum | 100 |

1.-8. (canceled)

9. A method for controlling phytopathogenic fungi or harmful fungi in the protection of a material, wherein the fungi or the material, plants, soil or seed to be protected against fungal attack are treated with a fungicidally effective amount of a composition comprising an amidrazone of the formula I 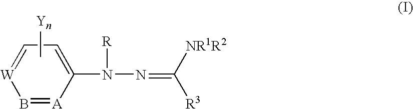
wherein
R is hydrogen, C₁-C₆-alkyl, C₁-C₆-alkoxycarbonyl, C₁-C₆-alkylaminocarbonyl, or di(C₁-C₆-alkyl)-aminocarbonyl,
wherein in each of the above radicals the alkyl group is unsubstituted or substituted with 1 to 3 substituents independently selected from the group consisting of halogen, cyano, nitro, C₁-C₆-alkoxy, C₂-C₆-alkenyloxy, C₂-C₆-alkynyloxy, C₁-C₆-haloalkoxy, C₁-C₆-alkylthio, C₁-C₆-haloalkylthio, C₁-C₆-alkylsulfonyl, C₁-C₆-alkylsulfinyl, and di(C₁-C₆alkyl)-amino;
R¹ and R² are each independently hydrogen, C₁-C₁₀-alkyl, C₃-C₁₀-alkenyl, C₃-C₁₀-alkynyl, C₃-C₁₂-cycloalkyl, C₁-C₆-alkylamino, di(C₁-C₆-alkyl)-amino, C₁-C₆-alkylcarbonylamino, C₁-C₆-alkylsulfonyl, or C₁-C₆-alkylsulfinyl,
wherein in each of the above radicals the alkyl, alkenyl, alkynyl or cycloalkyl groups are unsubstituted or substituted with 1 to 3 substituents independently selected from the group consisting of halogen, nitro, cyano, C₁-C₆-alkoxy, C₁-C₆-haloalkoxy, C₁-C₆-alkylthio, C₁-C₆-haloalkylthio, C₁-C₆-alkylsulfonyl, C₁-C₆-alkylsulfinyl, C₁-C₆-haloalkylsulfonyl, C₁-C₆-haloalkylsulfinyl, C₃-C₆-cycloalkyl, phenyl, and pyridyl;
R³ is C₁-C₁₀-alkyl, C₂-C₁₀-alkenyl, C₂-C₁₀-alkynyl, C₃-C₁₂-cycloalkyl,
wherein in each of the above radicals the alkyl, alkenyl, alkynyl or cycloalkyl groups are unsubstituted or partially or fully halogenated and/or substituted with 1 to 3 substituents independently selected from the group consisting of cyano, nitro, hydroxy, mercapto, amino, C₁-C₆-alkyl, C₃-C₆-cycloalkyl, C₁-C₆-alkoxy, C₁-C₆-alkylamino, di(C₁-C₆-alkyl)-amino, C₁-C₆-alkylthio, C₁-C₆-alkylsulfonyl, and C₁-C₆-alkylsulfinyl,
or a 3- to 6-membered saturated or partially unsaturated ring which may contain 1 to 3 heteroatoms selected from the group consisting of oxygen, sulfur and nitrogen, and which is unsubstituted or substituted with 1 to 5 substituents independently selected from the group consisting of halogen, C₁-C₆-alkyl, Cᵢ-C₆-alkylthio, C₁-C₆-alkylsulfonyl, C₁-C₆-alkylsulfinyl, C₁-C₆-alkoxy, C₁-C₆-haloalkoxy, nitro and cyano, wherein in each of the above radicals the alkyl group is unsubstituted or substituted with 1 to 3 halogen atoms;
A is C—R⁴ or N;
B is C—R⁵ or N;
W is C—R⁶ or N;
with the proviso that one of A, B and W is other than N;
R⁴, R⁵, R⁶ are each independently hydrogen, halogen, nitro, cyano, amino, mercapto, hydroxy, C₁-C₁₀-alkyl, C₂-C₁₀-alkenyl, C₂-C₁₀-alkynyl, C₃-C₆-cycloalkyl, C₁-C₆-alkoxy, C₁-C₆-alkylamino, di(C₁-C₆-alkyl)-amino, C₁-C₆-alkylthio, C₁-C₆-alkylsulfonyl, C₁-C₆-alkylsulfinyl, or a 5- to 6-membered aromatic ring which may contain 1 to 4 heteroatoms selected from the group consisting of oxygen, sulfur and nitrogen;
Y is hydrogen, halogen, cyano, nitro, amino, hydroxy, mercapto, C₁-C₆-alkyl, C₂-C₁₀-alkenyl, C₂-C₁₀-alkynyl, C₃-C₆-cycloalkyl, C₁-C₆-alkoxy, C₁-C₆-alkylamino, di(C₁-C₆)-alkylamino, C₁-C₆-alkylthio, C₁-C₆-alkylsulfonyl, or C₁-C₆-alkylsulfinyl; and
n is 0, 1, or 2.

10. The method of claim 9, wherein A is C—R⁴ wherein R⁴ is halogen or C₁-C₆-haloalkyl, B is C—R⁵ wherein R⁵ is hydrogen or halogen, W is C—R⁶ wherein R⁶ is halogen or C₁-C₆-haloalkyl, Y is a halogen atom in the 6 position of the aromatic ring, n is 1, R is hydrogen or C₁-C₆-alkyl, R¹ is hydrogen, R² is C₁-C₄-alkyl, R³ is C₁-C₁₀-alkyl or a cyclopropyl group of the formula II 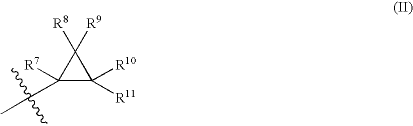
wherein R⁷ is hydrogen, C₁-C₆-alkyl or C₁-C₆-haloalkyl, and R⁸, R⁹, R¹⁰ and R¹¹ are each independently selected from the group consisting of hydrogen, halogen, C₁-C₆-alkyl and C₁-C₆-haloalkyl.

11. The method of claim 9, wherein A is C—Cl, B is CH, W is C—CF₃, Y is a chlorine atom in the 6 position of the aromatic ring, n is 1, R and R¹ are both hydrogen, R² is ethyl, and R³ is tert-butyl or 1-(2,2-dichloro-1-methyl-cyclopropyl).

12. The method of claim 9, wherein the material being protected is selected from wood, paper, paint dispersions, fiber and fabrics.

13. The method of claims 9, wherein the composition further comprises a fungicidal compound II.
